(19) United States
(12) Patent Application Publication
(10) Pub. No.: US 2026/0339942 A1
(43) Pub. Date: Oct. 29, 2026

(54) System and method for processing data

(71) Applicant: Stream Analyze Sweden AB, UPPSALA (SE)

(72) Inventors: Johan Risch, UPPSALA (SE); Tore Risch, UPPSALA (SE); Fredrik Carlqvist, UPPSALA (SE)

(21) Appl. No.: 19/701,785

(22) Filed: Jun. 9, 2026

Related U.S. Application Data
(63) Continuation of application No. PCT/SE2024/051069, filed on Dec. 13, 2024.

(30) Foreign Application Priority Data
Dec. 15, 2023 (SE) 2351429-2

(51) Int. Cl. G06F 16/2453; G06F 8/41; G06F 16/22

(52) U.S. Cl. CPC G06F 16/24534; G06F 8/437; G06F 16/2264

(57) ABSTRACT

A method for processing multi-dimensional data in a computer system having a database. A non-procedural declarative definition of a data array is identified or provided, comprising the rank and shape of the array and syntactically in the form of a query to the database. Respective values of individual array elements are defined using query conditions constraining the values, with at least one value defined in terms of queried data fetched from a dataset as specified in the query. A naïve query representing a straight-forward generation and computation of the query is generated, defining a respective condition so constraining each array element's value. The naïve query is optimized using a query optimizer, yielding a procedural execution plan specifying both the data structure used to represent the array elements and a defined order of calculations for determining their values. The optimizing determines both. The array element values are then computed by executing code of the execution plan.

### TECHNICAL FIELD

The various embodiments described herein relate to a system and a method for processing data, in particular multi-dimensional data.

### BACKGROUND

Structured Query Language (SQL) has become the key enabler in database management systems (DBMSs) for scalable and user-oriented search in large databases. Query languages so such as SQL enable non-experts to interactively specify non-procedural or declarative queries where the user specifies what to retrieve from a database rather than specify how algorithms used in the search are utilized. In general, the semantics of declarative relational database queries are expressed by firstly, in a generator stage, combine all possible rows in the queried tables and then, in a filter stage, select those rows that fulfil the query condition.

Declarative queries can be seen as expressing the query result as a constraint among the possible rows in the generator stage, without specifying details on how to fulfil the constraint. The following is an example of this.

Say that we want to retrieve a subset, from a larger dataset, of persons earning more than 50,000. With a so-called table comprehension, a query returning the names of such persons can be expressed with the following formula using an SQL expression:
SELECT e.name, d.name FROM employee e, department d WHERE e.salary >50000 AND d.dno=e.dno

This type of notation is also called tuple calculus since all variables in a query (e and d in the example) are bound to rows in tables (employee and department in the example). The naïve query semantics is to first generate the cross product of the rows of the tables in the FROM clause (employee and department), then to apply the filter in the WHERE clause on the rows of the cross product (e.salary >50000 AND d.dno=e.dno), and finally to pick up (project) the attributes specified in the SELECT clause from the rows produced by the filter (row attributes name and dname). With, for instance, 10,000 employees and 100 departments, the generator phase will produce a million rows to be filtered. Therefore, some type of query optimization is clearly needed as data grows.

To perform such query optimization, it is up to a query optimizer in the DBMS to automatically generate, for a given database query, a program that performs the search as efficiently as possible. The generated program is called an execution plan. For a given declarative query there may be very many possible execution plans, using different algorithms and strategies with extremely large differences in performance. Typically, the query optimizer will choose the most efficient (near optimal) one based on database statistics and properties of suitable algorithms for the retrieval.

One may regard SQL as a highly optimized domain language for querying data stored in database tables. Before the advent of database query languages, the retrieval programs had to be explicitly implemented as procedural programs where all details of the retrieval were explicitly specified. SQL has been shown to improve the time and effort to search a database compared to writing procedural programs. It enables non-expert programmers to work efficiently with relational databases.

However, numerical computation over arrays continues to present problems. Computations over arrays of numbers are central in many fields, for example image processing, statistical models, and various kinds of AI algorithms. Used arrays of data are often very large, so computational efficiency is normally important.

One known way to enable very high performance in such cases is to implement highly optimized programs in an efficient low level programming language, such as C/C++, that utilizes highly optimized low-level numerical libraries such as BLAS. This is analogous to database programming before SQL. These highly optimized and complex programs are, however, difficult to develop and maintain.

An Internet of things (IoT) environment typically comprises a plurality of physically separated edge devices and possibly one or several central devices, all such devices being interconnected for digital communication such as over the Internet. In such an environment, software functionality comprising array processing of the presently described types can be distributed, the software being deployed and operative across various parts in such an environment. For instance, the processing of data collected by such edge devices, and the producing of processed data useful for automatically determining and performing various actions, can employ such array processing.

In IoT applications, it is known to use more or less autonomous edge devices, that can be used as sensors and/or actuators in an IoT system. Such edge devices may be based on hardware and also more or less on software. For instance, such edge devices may be arranged with purpose-made hardware implementing certain logic, or be generally programmable, running operating systems such as FreeRTOS or Android©. Hardware can comprise CPUs (Central Processing Units), GPUs (Graphics Processing Units) and/or FPGAs (Field-Programmable Gate Arrays).

Normally, once such a system is installed, together with edge devices, the installation tends to be relatively static. For instance, in many conventional systems activities such as add-on installations, testing, simulations, functionality changes and so forth are time-consuming. Even if edge devices can be configured using parameters or similar, their functionality may be limited to use cases envisioned by an installing operator.

Hence, one problem with conventional distributed IoT systems is flexibility of functionality, both in terms of initial design, deployment and further development and updates. This is particularly true when dealing with existing and legacy hardware.

Another problem is performance and scalability, in view of the massive amounts of measured data that many such systems need to manage. Often real time requirements are challenging, and available hardware resources at each edge component are often limited.

Yet another problem is maintenance, including testing and simulating new or hypothetical operation scenarios.

Another problem is usability. It would be desirable for a system not to require deep knowledge in programming or of the technical details of the system to be able to deploy, use, develop and maintain it in a broad spectrum of applications.

It would hence be desirable to provide a massively scalable IoT system, including a plurality so of edge devices and possibly one or several central units, which offers improved flexibility in terms of functionality, both during design, deployment, further development and maintenance, and which is simple to deploy.

SE 2050998-0 A discloses a general configuration of a massively distributed system capable of achieving at least one of the above-described goals. SE 2350183-6 discloses a way to process queries in such a massively distributed system using partially compiled execution plans.

Multi-dimensional array queries provide a form of comprehension by specifying arrays declaratively. In general, comprehensions are high-level ways of specifying collections such as sets and lists. It is used in several programming languages (see https://en.wikipedia.org/wiki/Set-builder_notation). Relational database queries (e.g. the SELECT statement in SQL) can be regarded as declarative table comprehensions(https://dl.acm.org/doi/pdf/10.1145/181550.181564). With table comprehension, all variables in queries must be bound to rows in tables and the result of a query is a new table.

Some programming languages provide 1-d array comprehension, e.g. Python list comprehension (see https://en.wikipedia.org/wiki/List comprehension) in Python and in JavaScript (https://reference.codeproject.com/javascript/reference/opera tors/array_comprehensions). The array elements are assigned there procedurally through for-loops. The procedural specification prohibits query optimization.

Multidimensional arrays are there represented as nested 1-d arrays (https://rowannicholls.github.io/python/advanced/lists.html).

The nested representation of 1-d arrays is inefficient. Efficient programming of numerical models in Python requires calling low level dense array primitives in BLAS through the NumPY interface. The programming language Julia provides procedural array so comprehension without declarative queries (https://chifi.dev/the-awesomeness-of-array-comprehension-syntax-in-julia-f6bf61479cf5).

In the database field, Rasdaman provides multi-dimensional arrays in its query language RasQL(https://doc.rasdaman.org/9.7/04_ql-guide.html).RasQL provides a library of standard functions for manipulating raster images based on a scalable representation in disk-based databases of partitioned dense arrays called tiles. Some of the RasDaman functionality has been added to the SQL standard. There are similar libraries in PostGis (https://en.wikipedia.org/wiki/PostGIS) and Oracle GeoRaster (https://en.wikipedia.org/wiki/Oracle_Spatial_and_Graph).The main aim of these so-called spatial database representations is to enable scalable search in large collections of images stored in databases through libraries of common image raster operators implemented as foreign functions in the query language. The term “vectordatabases” (https://learn.microsoft.com/en-us/semantic-kernel/memories/vector-db) has recently gained increased popularity. They are also databases storing large quantities of 1-d vectors, similar to spatial databases. The vectors can be, e.g., numerical feature vectors extracted from images. An important property of vector databases is to enable queries that find vectors close to each other based on some distance measure, so called similarity search (https://en.wikipedia.org/wiki/Similarity search).

### SUMMARY

Hence, in one aspect, the invention relates to a method for processing multi-dimensional data, comprising the steps
identifying or providing a non-procedural declarative definition of a data array, the definition comprising the rank and a shape of the data array, the definition being syntactically in the form of a query wherein respective values of individual array elements are defined using query conditions constraining the values;
generating a naïve query representing a straight-forward generation and computation of the query, the naïve query defining a respective condition constraining the value of each array element;
optimizing the naïve query using a query optimizer, yielding a procedural execution plan arranged to, when run, determine the respective values of the array elements, the execution plan comprising both information regarding what data structure is used to represent the array elements and also a defined order of calculations involved to determine the values of the array elements, the optimizing comprising determining both the information and the defined order; and
calculating the respective values of the array elements by executing or running computer code of the execution plan.

In some embodiments, the method further comprises, before the step of calculating, compiling at least part of the execution plan, yielding the computer code of the execution plan in the form of executable computer code arranged to, when executed, determine the respective values of one or several of the array elements, and the step of calculating comprises executing the executable computer code.

In some embodiments, the execution plan at least partly is in the form of interpretable computer code arranged to, when interpreted, determine the respective values of one or several of the array elements, and the step of calculating comprises interpreting the interpretable computer code.

In some embodiments, the execution plan comprises at least one algebraic transformation to be applied to calculate the value of at least one array element.

In some embodiments, wherein the algebraic transformation is a numerical algebraic or textual transformation.

In some embodiments, the calculation of the array values comprises at least one algebraic calculation to be performed to determine the value of at least one array element.

In some embodiments, the computer code is byte code or binary machine code.

In some embodiments, the data array has a rank of at least two.

In some embodiments, the definition defines at least one of the respective array values in terms of queried data that is fetched from a dataset as specified in the query.

In some embodiments, the definition comprises or uses integer index variables to refer to indices of the array.

In some embodiments, a procedural program code needed to compute the respective values of the array elements is defined for the first time by the execution plan.

In some embodiments, the definition comprises at least one variable, such as a parameter or a coefficient.

In some embodiments, the definition comprises a data type declaration for the variable.

In some embodiments, the execution plan is a typed execution plan, such as a statically typed execution plan.

In some embodiments, the naïve query is a typed query wherein at least one, some, or even all, used variables is or are unambiguously typed.

In some embodiments, the method further comprises type-checking the correct use of the respective types of all variables in the definition, the naïve query and/or the execution plan.

In some embodiments, the method further comprises inferring static type of any intermediate variables of the definition, the naïve query and/or the execution plan.

In some embodiments, the method further comprises late binding of any variables of the definition, the naïve query and/or the execution plan, and/or any array elements, the type of which cannot be inferred.

In some embodiments, the method further comprises rewriting the naïve query by applying rules, such as logic or mathematical rules, such as comprising one or more of
a) identifying and combining overlapping expressions of query fragments in the naïve query;
b) evaluating static expressions in the naïve query;
c) predetermined specific rewrite rules identified using pattern matching; and
d) removing redundant or not-used query fragments in the naïve query.

In some embodiments, the method further comprises rewriting the execution plan by applying logic rules, such as comprising one or more of
a) identifying and combining overlapping expressions in the execution plan;
b) evaluating static expressions in the execution plan;
c) predetermined specific rewrite rules identified using pattern matching; and
d) removing redundant or not-used expressions in the execution plan.

In some embodiments, the rewriting of the execution plan is arranged to preserve the procedural execution order of the execution plan.

In some embodiments, the optimizing comprises reordering and/or transforming the predicates in each query section of the naïve query.

In some embodiments, the execution plan is or comprises a procedural program where the order of execution of query operations to perform is explicitly specified.

Furthermore, in one aspect, the invention relates to a method for collecting data in a system, the system comprising several edge computing devices and at least a first central server, each such computing device and each such central server in turn comprising a memory; a Central Processing Unit, CPU; and a digital communication interface, arranged to allow digital communication across a digital communication network, each of the edge computing devices also comprising a sensor, the method comprising the steps
a) the central server accepting, from a querying party and via the digital communication interface, the query as a first query, or a second query comprising or referencing the first query;
b) the central server parsing the first query to produce a parsed query expression;
c) the central server producing, by generating and optimizing the naïve query, an execution plan in turn defining a calculation to be performed based on a measured value from the sensor;
d) the central server compiling at least part of the execution plan to thereby obtain an at least partly compiled execution plan;
e) at least one of the edge computing devices receiving, via the digital communication interface, the at least partly compiled execution plan; and
f) a software function of the at least one of the edge computing devices executing on the CPU of the edge computing device, running the at least partly compiled execution plan to produce a first result to the at least partly compiled execution plan, the interpretation comprising the performance of the calculation.

In another aspect, the invention relates to a system for processing multi-dimensional data, the system being configured to identify a non-procedural declarative definition of a data array, the definition comprising the rank and a shape of the data array, the definition being syntactically in the form of a query wherein respective values of individual array elements are defined using query conditions constraining the values; generate a naïve query representing a straight-forward generation and computation of the query, the naïve query defining a respective condition constraining the value of each array element; optimize the naïve query using a query optimizer, yielding a procedural execution plan arranged to, when run, determine the respective values of the array elements, the execution plan comprising both information regarding what data structure is used to represent the array elements and also a defined order of calculations involved to determine the values of the array elements, the optimizing comprising determining both the information and the defined order; and calculate the respective values of the array elements by executing or running computer code of the execution plan.

In some embodiments, the system comprises several edge computing devices and at least a first central server, each such computing device and each such central server in turn comprising a memory; a Central Processing Unit, CPU; and a digital communication interface, arranged to allow digital communication across a digital communication network, each of the edge computing devices also comprising a sensor; and wherein the functions of identifying, generating, optimizing, compiling and calculating each is performed by a respective one of the edge computing devices and/or central servers.

In yet another aspect, the invention relates to a computer software product for processing multi-dimensional data, the computer software product being configured to, when executed, identify a non-procedural declarative definition of a data array, the definition comprising the rank and a shape of the data array, the definition being syntactically in the form of a query wherein respective values of individual array elements are defined using query conditions constraining the values; generate a naïve query representing a straight-forward generation and computation of the query, the naïve query defining a respective condition constraining the value of each array element; optimize the naïve query using a query optimizer, yielding a procedural execution plan arranged to, when run, determine the respective values of the array elements, the execution plan comprising both information regarding what data structure is used to represent the array elements and also a defined order of calculations involved to determine the values of the array elements, the optimizing comprising determining both the information and the defined order; and calculate the respective values of the array elements by executing or running computer code of the execution plan.

The computer software product can be implemented by a non-transitory computer-readable medium encoding instructions that cause one or more hardware processors located in at least one of computer hardware devices in the system to perform one or several of the methods described herein.

### DESCRIPTION OF DRAWINGS

In the following, the invention will be described in detail, with reference to exemplifying embodiments and to the enclosed drawings, wherein:

FIG. 1 shows a client device according to one embodiment;

FIG. 2 is an overview of a system according to one embodiment, suitable for performing a method of any of the types described herein;

FIG. 3 is an overview of a namespace server database configuration, according to one embodiment;

FIG. 4a is a first overview of an architecture of an interpreting software function, according to one embodiment;

FIG. 4b is a second overview of an architecture of an interpreting software function, showing more details than FIG. 4a of core functions of the interpreting software function, according to one embodiment;

FIG. 5 shows a federation of edge computing devices and central servers, according to one embodiment;

FIG. 6 is a flowchart illustrating a first method, according to one embodiment;

FIG. 7 is a flowchart illustrating a second method, according to one embodiment;

FIG. 8 is a flowchart illustrating a third method, according to one embodiment;

FIG. 9 illustrates an information flow in a system, according to one embodiment;

FIG. 10a illustrates an exemplary full-engine edge computing device, according to one embodiment;

FIGS. 10b-d illustrate first, second and third exemplary thin-engine edge computing devices, respectively, according to one embodiment;

FIG. 11 is a flowchart illustrating a fourth method, according to one embodiment; and

FIG. 12 illustrates an information flow in a system, according to one embodiment.

In the Figures, similar reference numerals are used to denote similar parts.

### DETAILED DESCRIPTION

The various embodiments of the present method and system described herein relate to data processing in an Internet of things (IoT) environment comprising a plurality of physically separated edge devices and possibly one or several central devices, all such devices being interconnected for digital communication such as over the internet. More particularly, in some embodiments the present invention relates to the processing of data collected by such edge devices, and for producing processed data useful for automatically determining and performing various actions. Furthermore, embodiments of the present invention relate to software functionality executable in such a system to perform such a method.

By contrast to the existing multi-dimensional arrays, the presently disclosed array comprehension, and in particular the presently disclosed multi-dimensional array comprehension, provides a mechanism to specify new such arrays based on mathematical formulations in declarative queries, as will be described in further detail below. Furthermore, allowing typed numerical variables in query conditions allows very flexible and powerful queries over the inside of such arrays.

With the approach presented here, among other things the problem is addressed of how to allow numerical domain experts that are not professional programmers to specify numerical computations in terms of queries over numerical arrays. The numerical models can be specified on a very high and user-oriented level in terms of a query language where the computations are specified declaratively as mathematical formulas without detailed specification of algorithms and strategies that are used in order to make the computation executable and efficient. To enable this, database query and other optimization strategies are extended with computer algebra and conventional compilation techniques in order to provide efficient numerical computations over large arrays.

In efficient programming languages such as C/C++, one key enabler for high performance execution is so-called static typing. This means that the types of all expressions in a program so are known at compile time, so that the compiler can generate efficient binary code.

Furthermore, for high efficiency, the programmer may override (cast) types of expressions to improve the compilation, which however may cause undefined behaviour (crashes) and makes the languages not type safe.

Skilled professional programmers have deep knowledge of how to utilize static and unsafe typing to develop highly efficient programs. By contrast, interpretative languages such as Python, JavaScript, and Lisp provide type safety by dynamic typing where the types of all expressions are checked at run time. This makes them easy to use by non-expert programmers, since mistakes are always caught and no crashes can happen. However, this also causes some of these languages to be very inefficient compared to statically typed languages such as C/C++.

One approach to circumvent this is to call highly optimized system libraries developed in C/C++ from the interpreted language. For example, NumPy provides interfaces between Python and the highly optimized low level BLAS library written in C and Fortran. For high performance, the programmer must formulate the program in such a way that time-critical operations are managed by suitable low-level subroutines called from the interpreted language. Furthermore, for performance, time-critical code in the interpreted language may need to be redeveloped as C/C++ code called from the interpreted language. This, again, makes the systems complicated and very difficult to maintain.

The presently proposed approach to solve the problem of enabling non-programming domain experts to generate highly efficient code for numerical computations is instead to allow typed numerical variables in computations specified as declarative queries over large arrays. Such numerical models can use the representation of numerical arrays (tensors) that are supported in numerical queries and models. In multi-dimensional array queries, it is often important to be able to perform efficient computations over array slices (https://en.wikipedia.org/wiki/Array_slicing), that specify areas in arrays over which computations are made. A slice can be, for example, a particular row in a matrix (i.e. a 2D array). Using the present approach, array slices in a multi-dimensional array query (see below) are translated into predicates (i.e. logical expressions or filters) being fragments of the full query.

Using the present approach, such numerical queries can be specified declaratively on a very high level. This enables non-expert programmers to easily develop mathematical models of data already in the queries. Query optimization followed by dynamic on-the-fly compilation (JIT, https://en.wikipedia.org/wiki/Just-in-time_compilation) can provide very high efficiency and interactivity. In some embodiments, the query optimizer first generates an optimized execution plan to do the computations. As a part of this, the optimizer can apply query optimization strategies combined with computer algebra transformations and/or compiler optimization techniques. For example, using computer algebra techniques numerical expressions can be simplified. Using logical transformations, common parts of query conditions can be combined (https://en.wikipedia.org/wiki/Unification_(computer_science)) to avoid unnecessary computations. This can be shown to increase the performance of queries containing array slices substantially. For example, the performance gain for processing images represented as multi-dimensional arrays becomes larger when the image resolution is increased.

The compiler can then generate, on-the-fly, binary code from the optimized execution plan. When possible, in order for the compiler to generate highly efficient binary code, the query optimizer can in some embodiments infer types of variables in the execution plan to enable compilation into highly efficient binary code. In cases where the type of an expression is not uniquely determinable, the query optimizer may be capable of inserting operators to dynamically check types at run time, so called late binding.

The compiler may not be able to generate binary code for the entire execution plan. In such cases, an execution plan interpreter can be arranged to execute any such non-compiled parts of the plan and to call binary code for the compiled part. For example, functions calls having late bound parameters can be interpreted.

Arrays, such as multi-dimensional arrays, and in particular tensors, are commonly used in mathematical models. In many applications, used multi-dimensional arrays are dense, meaning that most values are non-zero. For efficient processing, such arrays can be stored adjacently in computer memory areas.

The various embodiments of the present invention enable easy development and maintenance of declarative queries in terms of arrays that can be multi-dimensional and/or dense, herein denoted “array queries”.

On a general level, the following properties are desirable for the representation of array queries, and in particular multi-dimensional array queries:
1. It should be non-procedural, so that both constructing and accessing arrays can be defined using queries without deep programming knowledge. In addition to ease of use, this also enables the query optimizer to have freedom to produce efficient execution plans.
2. It should be natural, meaning that the formulation of queries should be easy to understand for domain experts (e.g. engineers and analysts) to enable them to easily define mathematical numerical models.
3. It should be efficient, by enabling the query optimizer to automatically generate highly optimized binary code. Furthermore, computational models in terms of mathematical functions over arrays, such as dense arrays, should be executed as efficiently as possible, utilizing libraries and hardware for scalable computations when possible.
4. The generated binary code should be compact and not use excessive memory. Furthermore, the internal data representation of dense arrays should be as compact as possible.

The above requirements are fulfilled by the principles described herein, in particular by providing a declarative query language construct in which the elements of arrays, such as multi-directional arrays, can be specified as database queries constraining the elements of the arrays. The queries can specify array elements as predicates (i.e. logical expressions) without any details on how they are computed in terms of procedural loops, assignments, conditions, tests, etc. Array elements can be used in general queries combining array accesses with other expressions. The present approach utilizes query optimization combined with compiler and computer algebra techniques to achieve high performance computations specified on a high level by domain experts without deep programming knowledge.

In the present approach, array comprehension, and in particular multi-dimensional array comprehension, is introduced to specify constraints on the results of queries that can take arrays as inputs and can produce new arrays as results.

Furthermore, in the present approach typed query variable declarations are introduced for highly efficient compilation and (multi-dimensional) array element generators, as well as implicit index variables constrained to natural numbers to enable simple and natural formulations of mathematical models.

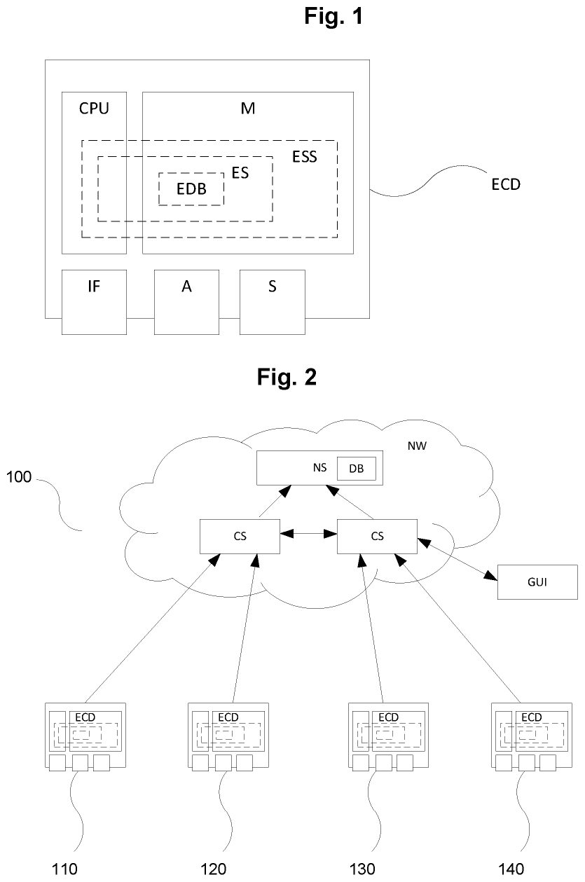

FIG. 2 generally shows a system 100 comprising several edge computing devices (ECD) 110, 120, 130, 140 of the general type shown in FIG. 1.

Each such edge computing device ECD is a piece of computing hardware, comprising a respective sensor S, a memory M, a Central Processing Unit CPU and a digital communication interface IF.

The sensor S may be any type of sensor arranged to measure a parameter at the edge computing device ECD in question. The parameter may represent a physical property at or near the edge computing device ECD, whereby the sensor may be a light sensor; a camera sensor; a temperature sensor; a sound sensor; an electric or magnetic sensor, such as a current, voltage, impedance or magnetic field sensor; an orientation sensor, such as a gyro or an accelerometer; a pressure sensor; a chemical sensor, such as a pH sensor or a sensor for sensing particular solid state, liquid and/or gaseous chemical substances; and so forth. The parameter may also represent a logical property available for reading by the edge computing device ECD, such as a settable gate; a push button; a logic state delivered by an auxiliary device; and so forth.

What is important in this context is that the sensor S is arranged to sense a certain condition at the “edge” location of the edge computing device ECD. That the computing device is an “edge” device means that it is physically located in a location where the sensed condition is relevant. The system 100 in general comprises a plurality of such edge computing devices ECD, each being located in a respective such physical location, the physical location for different edge computing devices ECD generally being different. This means that the system 100 covers a plurality of such physical locations where such measurements can be performed by the edge computing devices ECD. This way, data sensed from a plurality of different physical locations can be concatenated, combined and/or aggregated in the ways described herein, by one or several central servers CS in contact with the edge computing devices, to form a total view of some type of situation involving the plurality of physical locations.

Each central server CS mayor may not also comprise a sensor S of the type described herein.

The sensor S may comprise an analogue to digital converter, to convert a sensed analogue value, such as a temperature, to a digital representation which may be fed to the CPU.

Of course, each edge computing device ECD may comprise more than one sensor S, of the same and/or different types. All such sensors are connected to the memory M, such as via a suitable digital communication bus, so that a computer software function executing on the CPU can access measurement values received from the sensor S in question.

Similarly, each edge computing device ECD may furthermore comprise one or several actuators A, such as light, movement, electrical or magnetic actuators, as the case may be. All such actuators A are connected to the memory M, such as via the digital communication bus, so that a computer software function executing on the CPU can impart actuation at the actuator A in question.

The memory M may be a RAM memory, and is preferably a digital memory interconnected to both the sensor S and the CPU.

The CPU may be any suitable CPU, such as a single-core or multi-core CPU. The CPU may also be or comprise a GPU, FPGA, or other general-purpose computation processing hardware logic arranged for high-speed digital processing of data including calculations.

The edge computing device ECD may be a physically standalone, programmable device. It may be a general-purpose programmable device, or a programmable device which is hardware-limited to particular uses. It can be arranged to be programmable, such as using machine code that can be fed into the memory M from an external source and thereafter executed by the CPU. Only by way of example, the edge computing device ECD may be a programmable sensor or a PC laptop computer.

The edge computing device ECD may comprise an operating system, arranged to execute on the CPU and provide higher-level services to computer software executing on the CPU within the environment provided by the operating system. Such an operating system is, however, not necessary in all embodiments of the present invention.

The digital communication interface IF may be any suitable digital wired or wireless interface, arranged to allow the edge computing device ECD to communicate with external devices. For instance, the interface may be an internet interface, such as a socket; or a serial interface.

In particular, as illustrated in FIG. 2, the interface IF of each edge computing device ECD allows it to communicate digitally across a digital communication network NW, such as the internet, to which all system 100 devices are connected for communication.

In particular, one or several central servers CS, NS may be connected to the network NW for communication with the edge computing devices ECD. Each edge computing device ECD is connected to at least one, such as exactly one, such central server CS. The central servers CS may in turn be connected in one or several hierarchies, such as in a tree structure wherein a leaf (or client) central server CS is connected to a parent (or server) central server CS.

FIG. 2 also shows a particular type of central server, namely a namespace server NS (see below).

That the server is “central” means that it defines a functionality which is logically centralized, in the sense that it is accessible at a single well-defined logical place. For instance, the central server may be a conventional standalone server, in the form of a single piece of hardware having computer software executing thereon. However, each central server may also be embodied as a distributed logical server, such as a defined server functionality reachable via an internet “cloud”-type functionality. Hence, several such central servers CS may actually partly or fully execute on a common hardware platform, as the case may be. Such design options are selected from the point of view of, for instance, system 100 scalability, performance, security and resilience.

The present system 100 can be made very scalable, and may comprise at least 1000, such as at least 10000 or even at least 100000 connected edge computing devices ECD that are connected to the same system 100 in a way so that they can all communicate directly or indirectly with each other across the network NW as described herein.

Each central server CS may serve at least 10 edge computing devices ECD, such as at least 100 edge computing devices ECD. Each central server CS may furthermore serve at the most 10000 edge computing devices ECD, such as at the most 1000 edge computing devices ECD.

Each edge computing device ECD can also refer to other edge computing devices ECD across the network NW. Hence, data may flow in a tree-like structure formed by the system 100 comprising one or several layers of edge computing devices ECD forming leaves and nodes close to leaves in the tree structure, and also one or several layers of central servers CS further away from such leaves.

The interpreting software function ES described herein may be executed both on edge computing devices ECD and central servers CS, whereby both devices with their own sensors S and more centrally located devices that concatenate data streams rather than process data measured using own sensors can process queries of the type described herein. Then, each device running the interpreting software function ES can run the same interpreting software function ES, or variants or parts of the interpreting software function ES. At any rate, the various software instances are then compatible across the communicating devices, and are arranged to operate on and process the same query language (see below).

Hence, according to embodiments of the present invention each edge computing device ECD is arranged with a respective interpreting software function ES, illustrated in a simplified way in FIG. 1. The interpreting software function ES is arranged to execute on the respective CPU of the edge computing device ECD in question, such as locally on the edge computing device ECD, such as entirely locally on the edge computing device ECD.

“Local execution”, as used herein, means that the software code embodying the software function ES is loaded directly into the CPU of the edge computing device ECD and executed directly thereon, whereby all, or at least parts, of the logic or calculation functionality take place at the CPU of the edge computing device ECD as opposed to on CPUs of any external devices. Note that this does not rule out that data, in the sense of information, is communicated to and/or from the edge computing device ECD in question, which data may be used as a basis for the execution of the software function ES. For instance, the numeric working data product of one edge computing device ECD may be consumed by another edge computing device ECD to be used therein in further calculations. However, a “local execution” of a piece of software in its strictest sense rules out a distributed execution, for instance in the sense that different calculations to be performed by the software function ES are performed in different threads executed on different, disjoint hardware devices. In less strict cases, “local execution” can, however, entail certain functions or similar being performed on external hardware. Hence, the present inventor foresees that individual edge computing devices ECD may be arranged to share some software function ES functionality, even in a distributed execution environment involving a subset of such edge computing devices ECD. This may include one edge computing device ECD delegating to other edge computing devices particular defined calculations, in particular queries pertaining to sensors of such called-upon edge computing devices ECD. In general, embodiments of the present invention provide the greatest advantages in a hardware environment in which CPU-demanding calculations are performed as far out on the leaves (at the individual edge computing devices ECD) as possible, exploiting the CPU resources of all connected devices.

The software function ES can be an interpreting software function. This means that it is configured to accept information having a predetermined format, to step through the information in a particular order, and to interpret or execute one piece of the information at a time. Such information processed by the software function ES is herein denoted “computer code”, and is received by the edge computing device ECD in question via its digital communication interface IF and stored in its memory M. The computer code in turn can comprise definitions, statements and/or instructions that the interpreting software function ES is then configured to parse, process and/or execute. In this sense, a conventional Java virtual machine is an interpreting software function, albeit arranged to interpret Java code rather than, for instance, query-language computer code of the type described herein. The distinction to note here is the one between “interpreting” and “executing”, where the latter implies loading binary machine-code instructions into a CPU for direct execution by the CPU, whereas the former implies the interpreting software interpreting the computer code and in turn instructing the CPU. Expressed differently, an interpreted language is a language that contains at least some aspect or aspects not expressed in a native, directly executable machine language of the used CPU, but that need to be decoded somehow by an interpreter to be executable by the CPU.

The received, stored and/or interpreted computer code can be formatted according to a query language having a predetermined syntax. Herein, a “query language” is a language allowing a user to define queries onto a particular data set. For instance, conventional SQL is a query language, albeit not of the type generally described herein.

As opposed to SQL and many other conventional query languages, the syntax of the presently discussed query language can be arranged to define queries the results of which are possibly infinite streams of data. As used herein, a “stream” of data is a set of data pieces having a time dimension, preferably a set of data pieces continuously produced, perhaps even in real-time. Hence, each such piece of data may be associated with, or comprise, a timing information, such as a time of measurement, a time of sending, a time of reception and so forth. For instance, the edge computing device ECD may comprise a clock, which may be arranged to provide a time associated with each sensor S measurement, such as before the measurement in question is processed by the software function ES.

In some embodiments, each edge computing device ECD is arranged to, when interpreting the computer code using the software function ES, produce a result to at least one query defined by the computer code. As mentioned, the result may be a stream of data. The edge computing device ECD can then be further arranged to communicate the result in question, via its digital communication interface IF, to a querying device, such as a different edge computing device ECD or a central server CS. In general, the querying device may be any device, external to the edge computing device ECD, posing the query in question to the edge computing device ECD via its digital communication interface IF and thereafter receiving a response to the query. In some cases, the response may also be returned to a different entity than the one posing the query, depending on the detailed system configurations. In particular, the syntax may be arranged to allow queries in general, and in particular the query now in question, to be defined in terms of a calculation to be performed based on a measured value from the sensor S of the edge computing device ECD in question. Hence, the query language-formatted computer code interpreted by the software function may comprise a properly formatted direct or indirect reference to a particular sensor S of the edge computing device ECD, whereby the interpretation involves reading a current value of the sensor S in question and using that read current value in one or several calculations based on the result of which the query result is determined.

In some embodiments, it is the edge computing device ECD in question (the one on which the software function ES executes) that is arranged to perform, as a part of the interpretation, the calculation.

The system 100 may be designed so that it is self-contained in the sense that it is not dependent on other, external, systems for its operation. Still, it may be designed to provide powerful extensibility mechanisms to enable tight integration with software on many different hardware platforms. One key aspect of this is then the interpreting software function ES executing on several edge computing devices ECD, such as on each edge computing device ECD. Namely, this interpreting software function ES may be downloaded onto each individual edge computing device ECD and installed for (local) execution on the respective CPU of the edge computing device ECD in question. Once downloaded and installed, the software function ES of each such edge computing device ECD can interpret the computer code as long as the computer code adheres to the well-defined syntax.

In practice, the software function can be ported (translated) to be executable on many different hardware/software environments (such as different processor architectures and/or different operating systems). In this context, it is preferred that the interpreting software function ES is specifically adapted to each type of such hardware/software environments but providing the corresponding (or even logically identical) interpreting functionality with respect to the syntax.

The resulting agnosticism regarding environment, only requiring the software function ES to support certain predetermined functionality, enables a scale-down of the interpreting software function ES, so that it can run on edge computing devices ECD with very limited local hardware resources. On the other hand, the number of such small edge computing devices ECD can be very large, each running such a scaled-down interpreting software function ES.

At the same time, the system 100 allows for massive scale-up, by running many instances of the interpreting software function ES on different devices in parallel. In particular, the system 100 can be scaled up to run the interpreting software function ES in many copies on large multi-cores, clusters and clouds.

These concepts of scale-down and scale-up will now be briefly explained and exemplified.

Regarding first scale-down, the present inventor has successfully configured the interpreting software function ES so that it implements a required “kernel” software functionality, which may in turn be scaled down to run directly on small devices with limited or no operating system support. By porting the interpreting software function ES to various such limited resources environments, the present system 100 can be made virtually agnostic to the hardware, operating system and communication infrastructure used, by the interpreting software function ES running on each respective edge computing device ECD implementing a predefined minimum such kernel software functionality. Hence, each piece of interpreting software function ES can run completely stand-alone on a respective supported device or computer, forming an edge computing device ECD of the present type.

For some types of hardware, the present inventor has managed to design such a kernel software functionality so that it does not require operating system support, but can run on bare metal. In fact, it has turned out that the smallest possible configuration of a kernel-only system K requires less than 20K RAM (transient memory) and only 300K persistent, non-transient memory such as flash memory.

The kernel software functionality may be comprised as a part of the interpreting software function ES. For instance, the kernel software functionality may provide required interpretation functionality for a well-defined core part of the query language, including syntax parsing, while the rest of the software function ES, including non-required functions and similar, may add higher-level functionality.

In general, since different ones of the edge computing devices ECD may comprise different hardware configurations, the interpretation software function ES may be specifically adapted to the respective hardware configuration of each type of the different edge computing devices ECD, whereas the syntax may be identical for each of the different edge computing devices ECD.

In some embodiments, as illustrated in FIG. 1, designed to offer tight integration of the interpreting software function ES with other (system 100 external) software running on the same edge computing device ECD, the interpreting software function ES may run as an embedded engine inside other embedding software systems ESS.

Regarding the scale-up, reference is made to FIG. 2 illustrating how very large numbers of such scaled-down edge computing devices ECD can be interconnected to form one single, distributed system 100, encompassing many different edge computing devices ECD and central servers CS.

To achieve this, each edge computing device ECD can be managed by a particular central server CS, that may itself run as a cloud service over network NW.

As mentioned above, the interpreting software function ES may be designed with a necessary kernel functionality, including support for interpreting computer code query syntax interpretation and communication over interface IF. For very limited hardware environments, this kernel alone may constitute the entire interpreting software function ES. Then, various non-necessary add-on functionality can be added, depending on the hardware limitations of the edge computing device ECD on which the software function ES is to execute and depending on the general system 100 configuration.

In some embodiments, each sensor S and/or edge computing device ECD is referable, according to the above-mentioned syntax, using a global namespace or set of properties. For instance, each edge computing device ECD may be allotted a unique number or name, or a unique network NW address may be used as a unique identifier for each edge computing device ECD. Each sensor S of an edge computing device ECD may similarly be addressable using the same or a different identification standard. A simple example of such a name standard is “[ECD_NO].[SENSOR_NO]”. Preferably, sensors of identical type may be denoted using the same sub-name according to the name standard.

In the example shown in FIG. 2, a system 100 globally-unique identity of each edge computing device ECD is registered with a respective central server CS running on some server in turn connected to the network NW; in a container or a PC; or even as a separate process on the same computer as the computer on which the edge computing device ECD interpreting software function ES executes. In the latter case, the central server CS and the edge computing device ECD actually run on the same hardware, but are logically and functionally separated. Each central server CS may serve several edge computing devices ECD, to achieve the tree structure with respect to data flow in the system 100. In general, however, the edge computing devices ECD and central servers CS discussed herein can all be embodied as discrete respective hardware entities, physically separated one from the other.

In FIG. 2, there are two central servers CS running in the network NW, and four different edge computing devices ECD are registered.

The system may further in general comprise a central namespace server NS, which may be arranged with a database DB in turn comprising information defining names for each of the edge computing devices ECD. The database DB may be comprised in or connected to the namespace server NS.

The database DB may comprise information regarding network address locations for each of the edge computing devices ECD. The database DB may further comprise metadata information regarding individual edge computing devices ECD, for instance concerning what types of sensors S are available at each such edge computing device ECD, what type and/or version of the interpreting software function ES is executed on each edge computing device ECD, numerical properties used when each edge computing device ECD delivers measurement values (such as what units are used), and so forth. This metadata may then be used to determine parameter values to use in the below-described query preprocessing performed by certain edge computing devices ECD.

In general, the namespace server NS may itself be a central server CS of the above-described type, having additional namespace information processing functionality and arranged to serve system 100 actors with namespace-related information services and requests.

All edge computing devices ECD are interconnected by network NW via the central servers CS and, if used, at least one such namespace server NS.

As mentioned, different instances of the interpreting software function ES running on different computers can communicate with central servers CS running on the same or some other computer. Each edge computing device ECD can communicate with the central server CS where it is configured to be registered. The serving central server CS in question can keep some metadata about each edge computing device ECD which it serves, and can forward data and streams to other central servers CS, such as for distribution to edge computing devices ECD served by such other central servers CS.

In general, all connected devices, and in particular the edge computing devices ECD, can run independently from each other. In particular, an edge computing device ECD may not be required to be continuously connected with its central server CS, as long as the edge computing device ECD in question is registered with the central server CS in question. The actual digital communication of object streams between the edge computing device ECD and the central server CS in question may be started and finished only when so required. When there is no active communication going on, the edge clients may be able to run autonomously.

This functionality can be implemented as a part of the digital communication interface IF, and decreases network NW traffic to a minimum, allowing for massive scalability. Of course, heartbeats and similar keep-alive signals can be sent between devices to keep a registered connection active. However, even this type of periodic communication may be not necessary, since an edge computing device ECD which is not online will simply not respond to queries posed to it.

Each edge computing device ECD can comprise a local database EDB to store local metadata about the edge computing device ECD and/or its sensors. This enables autonomous access to local metadata on edge computing devices ECD without requiring the namespace server NS to be contacted. This furthermore decreases the data traffic to the namespace server NS.

Hence, the system 100 can comprise a set of interconnected peer devices, in turn comprising a plurality of devices selected from the following list:
The interpreting software function ES running as an embedded piece of software on some or all network NW connected device;
A local database EDB on or at each of one or several of the connected devices;
A dedicated edge computing device ECD running the interpreting software function ES;
A central server CS; and
A namespace server NS.

In practice the system 100 may comprise a massive number of such interconnected peer devices, in particular very many edge computing devices ECD. It is therefore desirable to be able to scale out the numbers of peers to manage extremely large numbers of edge computing devices ECD, from tens of thousands up to billions. This can be managed by scaling out the number of edge computing devices ECD registered in each central server CS to thousands of edge computing devices ECD registered with each central server CS, and by defining a hierarchy of several hierarchy levels as described above.

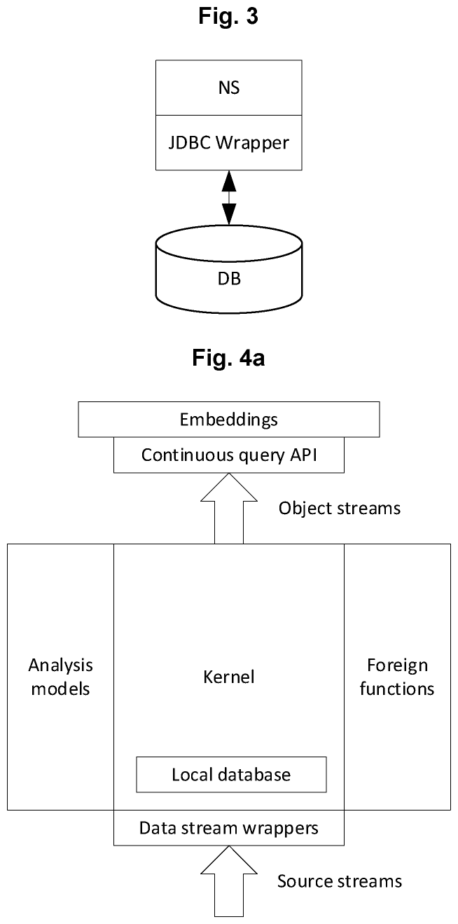

The system 100 of such interconnected peers should persist even when parts of the system 100 go down. To this end, the database DB of the namespace server NS may be a wrapped database, such as a wrapped relational database, as exemplified by FIG. 3 using a per se conventional JDBC (Java DataBase Connectivity) wrapper.

In this particular example, the wrapper may be a plug-in to the interpreting software function ES that enables access to any relational database using a standard database interface, such as the JDBC interface. The database DB may hold the identifiers of all peers in the system 100, along with other metadata such as what kind of equipment is accessible through each edge computing device ECD, what kind of sensors S they access, and so forth.

It should be noted that it is also possible to implement a namespace server NS of the present type without a database backend, and in this case it is also possible for such a namespace server to persist its database. However, in order to scale to millions of interconnected peers in the system 100, it is preferred to use a wrapped database DB as described.

It is further understood that the namespace server NS and/or its database DB may be implemented as a defined server functionality executing in a distributed hardware environment.

As mentioned above, the central servers CS and the namespace server(s) NS can be configured to run on many different kinds of hardware configurations, and also in different software environments. In a simple case, they can each run on a regular PC. In more scalable configurations, each central server CS can run in a separate container (such as Docker, see www.docker.com) and the namespace server NS, along with the relational database DB, so can run on a dedicated cluster. With such a scale-out, if the number of edge computing devices ECD registered with each central server CS is 1000 and with two levels of central servers CS, up to about 109 peers can be managed. The database DB will not be a bottleneck in such a configuration, as a limited amount of metadata per peer could be stored there.

In general, the interpreting software function ES can provide general data analytics and inference capabilities to the edge computing device ECD on which it is running. This functionality may generally be implemented in the same logical and functional manner on different ported versions of the interpreting software function ES, so that the interpreting software function ES with respect to these functions is independent from the particular hardware/software environment in which it executes. In general, the functionality of the interpreting software function ES described herein can be implemented in a way making it agnostic to hardware, operating system and communication infrastructure of the device on which it runs. In an exemplifying embodiment, the kernel of the interpreting software function ES may be written in the computer language C99.

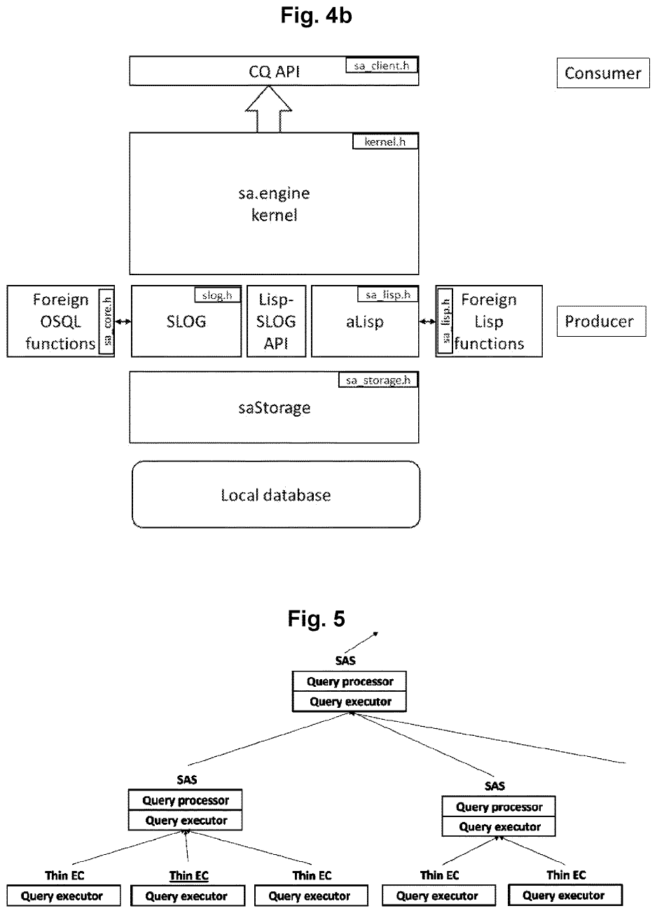

FIG. 4a illustrates the main components of such an interpreting software function ES.

The core of the interpreting software function ES is the above-mentioned kernel. It provides the generic capabilities needed for real-time data stream analytics. It contains a computational engine, a data stream processor, and an inference engine. It may also comprise a main memory local database EDB (see FIG. 1), which may be an object-oriented database and may further be comprised in the main memory M of the edge computing device ECD in question. Using such a locally provided database, and in particular an object-oriented database, in the edge computing device ECD, enables the use of a powerful query processer and optimizer where, for instance, analysis models and edge computing device ECD metadata may be stored and managed.

Furthermore, object-oriented data models describing metadata properties of the edge computing device ECD in question (such as information regarding the type or properties of edge computing device ECD sensors S, measurement units used by the edge computing so device ECD, edge computing device ECD hardware specification or properties, and so forth) enable the requesting from an edge computing device ECD regarding information about edge computing device ECD properties, conversions of names and measurements, and so forth (so called “mediation”). Such requests can be made using the query language, and result in that the response to such a query language query depends on particular metadata information stored in the queried edge computing device ECD, or even in other edge computing devices ECD subqueried in a query cascade of the general type described herein.

The database EDB can also store any execution plans to be executed on the edge computing device ECD, which enables dynamic replacements of the execution plan as database updates without the need for a firmware update.

The kernel comprises the data stream interpretation functionality. The kernel can be tightly integrated with an interpreter for execution plans over digital data streams called SLOG (Streamed LOGic), and also with an interpreter for some interpreted procedural language. The present inventors have successfully used a dialect of CommonLisp called aLisp (building on the conventional computer programming language family Lisp). Other useful alternatives of interpretable procedural languages include LUA and even OSQL itself in case the latter is extended with sufficiently procedural structure. In fact, the present inventor has discovered that building at least the kernel part of the interpreting software function ES in a computer programming language that uses functional notation, such as a Lisp language, provides a very efficient processing of the type of continuous queries processed by the present system 100 as described herein.

The upwards-facing arrows of FIG. 4a indicate data streams. One or several sensors S of the edge computing device ECD in question and/or the respective interpreting software function ES of one or several other edge computing devices ECD produce incoming source data streams that are injected into the kernel shown in FIG. 4a, which in turn transforms these incoming digital data streams into one or several new digital object streams for output from the edge computing device ECD in question.

Such a source data stream may be implemented as an access for the kernel to a raw sensor S interface on the edge computing device ECD on which the interpreting software function ES is running. A source stream can also be a data stream produced by a respective interpreting software function ES running on another connected edge computing device ECD, received via network NW, such as using the TCP communication protocol. For instance, such a source stream may be communicated in response to a continuous query posed by the interpreting software function ES receiving and consuming the source stream in question.

Analogously, the resulting object data streams may be sent to other central servers CS and edge computing devices ECD using the communication infrastructure (such as TCP) offered by network NW. This way, very large distributed systems 100 of peers of the present type can be configured, in which such peers produce object data streams for consumption by other peers as source data streams. On edge computing devices ECD, object stream data elements of calculated or received object data streams can be sent directly to actuators A mounted on the edge computing device ECD in question, and this way activate actuation of the actuator A in question.

In general, the system 100 and methods described herein can be specifically designed for simple and interactive development and deployment of applications that process and analyze real-time streams of data in distributed and mobile environments, allowing streams that are produced by sensors S on edge computing devices ECD to be analyzed, processed and aggregated online, in real-time and interactively.

An edge computing device can be, for instance, an Android unit, a PC desktop computer, a Raspberry Pi, or MCUs (Micro Controller unit) like MangOH Red or ARM M4. As described above, the interpreting software function ES, and in particular the kernel, can be designed to have a very small footprint (the present inventor has managed to slim the fully functional interpreting software function in test environments to total RAM memory M footprints ranging from about 20 kB to about 7 MB, depending on configuration), and to be essentially hardware and operating system agnostic, as well as fully independent of any third party software.

The combination in each of the edge computing devices ECD of a respective main-memory M database EDB, a software-implemented computational engine, a software-implemented data stream processor, and a software-implemented inference engine allows the use of edge analytics directly on the edge computing devices ECD. This is in contrast to many conventional approaches, in which all measurement data is first uploaded from edge devices to a central server, and in which the central server then performs all the data processing centrally. The present approach instead allows for drastic data reduction by processing the data streams already in the edge computing devices ECD. This way, only aggregated analyses, such as population analyses, over collections of connected edge computing devices ECD need to be made centrally or semi-centrally, such as on different aggregation levels in the tree structure data flow.

This way, the interpreting software function ES has a filtering capability, in other words it is arranged to filter out (discard) data from an available source data stream to produce an output object data stream containing less data per time unit than the source data stream.

In some configurations, the interpreting software function ES can also assume a data stream server role, either when running on an edge computing device ECD or on a central server CS. In such a data stream server role, the interpreting software function ES can be configured to collect data from one or several connected edge computing devices ECD and to combine and forward the combined/processed data as an object data stream to other peers. For example, whenever the analysis model in some edge computing device ECD detects strong vibrations, by performing a computation over the latest readings from its accelerometer sensor, an object data stream containing the frequency spectrum of the vibrations along with the geographical position of the edge computing device ECD in question may be transmitted to a stream server running on a central server CS, which in turn is configured to receive similar information from a plurality of different connected edge computing devices ECD. If the stream server receives many such streams at the same time, so from edge computing devices ECD in geographical positions close to each other, it may indicate an earthquake. The stream server may furthermore forward the received and possibly processed data to other connected system 100 peers or to an external system, such as for permanent central storage or batch analysis.

As mentioned above, the interpreting software function ES can be configured to interpret computer code formatted according to a well-defined query language syntax. Such a query language syntax can be selected to provide analysis of an available source data stream interactively and on a high and user-oriented level.

In particular, the query language may be a high-level object-oriented query language. The syntax may allow for different side effect free conditional logic-depending execution paths (such as “select-from-where” clauses), that are then interpreted and executed by the interpreting software function ES. The queries may be at least partly declarative in the sense that their interpretation and execution only result in searches of, and the performance of any calculations over, the database inside each respective edge computing device ECD, without updating these databases inside the edge computing devices ECD or changing the state of the device. However, the queries can also be at least partly non-declarative (see below).

In some embodiments, the query language may be designed to allow queries to have side effects such as updating databases, signaling actuators that change the state of the device, or sending messages to other edge computing devices ECD when such queries are loaded into the memory M of the edge computing device ECD on which the interpreting software function ES runs, and executed by the interpreting software function ES interpreting the query in question. In other words, when the interpreting software function ES executes on the edge computing device ECD in question and then interprets the loaded computer code, the programming embodied in the computer code, which may comprise the handling of states and/or side effects, is executed as a result of the interpretation.

Another term for a language being “declarative” is that it is “non-procedural”. Hence, the present query language can be configured to not be non-procedural, but rather to be at least partly procedural. Providing the query language as a declarative/non-procedural query language allows users to specify, in an intuitive manner, desired results in terms of output data, rather than exactly what the edge computing device ECD should do in terms of calculations to achieve the desired results. However, at the same time defining the query language so that it has certain non-declarative/procedural elements allows for queries to have side-effects and include stateful functions. When processing streaming data, such procedural/non-declarative elements of the query language provide the possibility to extract information from state-changing sensors.

The following is an example of a declaratively defined object-oriented query that returns a stream of objects for a given stream of sensors readings from an accelerometer sensor S:
select stream of absolute (shakes)
   from vector of number shakes,
where shakes from accelerometer( )

The query receives a set of acceleration readings as objects being 3D vectors shakes from a sensor accessed through the function accelerometer. It returns a stream of single numbers being the absolute values of the shakes objects. Here the function accelerometer( ) is stateful because it returns a new value every time it is called. The interpreting software function ES may in general be aware of the fact that queries contain calls to stateful functions, and be arranged to take this into consideration when parsing and interpreting queries. This provides for efficient and correct processing of queries of the type. Whenever the accelerometer emits new vectors, the query computes and emits its absolute value. Functions can also be expressed by queries. For example, the absolute function may be defined as

create function absolute(Vector of Number v) −> Number
as select sqrt(sum(v .\hat{ } 2))

The query select sqrt(sum(v.\hat{ }2)) takes a numeric vector object v as parameter and returns its absolute value.

In some embodiments, the computer code is formatted according to an object-oriented query language, allowing users to specify computations, filters and/or transformations over data streams at each connected edge computing device ECD. In other words, the present query language may be an object-oriented query language.

An object-oriented query language is a language supporting queries where variables are bound to objects of any kind (e.g. numbers, vectors, matrices, strings, records, key-value repositories, and so forth). Objects can even represent entire edge computing devices ECD making it possible to make queries over possibly large collections of edge computing devices ECD and edge computing device ECD internal databases EDB. In the code examples above, the variables shakes and v are bound to streams and vectors, respectively. This may be contrasted to relational query languages such as SQL, wherein variables in queries (SQL's select-statement) must be bound only to rows in tables. Such object-oriented query language may allow filtering out and transforming of data objects of any kind.

The present query language may in addition contain procedural (stateful) functions where the database EDB or the state of the edge computing device ECD itself is updated by calling the function. The query processor of the interpreting software function ES then has to consider that the order in which stateful functions inside the query are called is significant, since it will change the result. For example, database EDB accesses after a state change will produce different results than before.

It is noted that there exist procedural statements in, for instance, SQL, allowing manipulation of states and variables in the sense. However, in SQL queries (i.e. select-from-where statements) this is not allowed. Hence, one important difference between the present query language and for instance SQL is that the present query language allows for use of variables and/or stateful functions in queries that are defined using the query language and the syntax.

The result of an object-oriented query may also be a stream of objects. Such computations and filters over real-time streaming data may be defined, for instance using such an object-oriented query language, as mathematical formulas and expressions, herein denoted “stream models”. Such a stream model is a set of definitions of mathematical functions, filters, and other expressions, defined over a stream of data such as measurements. Using an object-oriented query language, the models can be specified on a very high level without the user needing deep programming knowledge. Instead of writing detailed programs expressing how to execute the models, it is instead possible to simply specify in the stream model what to do in terms of the final end result, and how that end result depends on any intermediate calculation results. The user needs not worry about details on how to efficiently implement algorithms that integrate large numbers of edge computing devices ECD and central servers CS to achieve a common goal in terms of data collection and processing.

In some embodiments, the stream of objects in a function returning a stream is stateful, e.g. by originating in a sensor S on an edge computing device ECD or the environment, such as is the case for accelerometer above. The query processor of the interpreting software function ES may therefore be arranged to consider side effects of such stateful stream functions when optimizing and executing the query. The order of the objects of the object data stream produced by such a query may furthermore also be significant and a function using or used by such a query therefore becomes stateful.

Even if much of the description provided herein, and many of the examples, assumes that the queries defined in the present query language are defined to return a result in the form of a stream of the type, it is understood that such queries can correspondingly also be defined to return a result in the form of a finite data structure, for instance so that a size of the result is known at the time of querying.

In some embodiments, the computer code may be provided to the edge computing device ECD, via the interface IF, as plaintext (as opposed to compiled/objective/machine code). In some embodiments, however, the computer code may be precompiled and be provided to the edge computing device ECD in non-plaintext, compiled into binary instructions format of the edge computing device ECD (the compilation may then be performed in a central server CS or somewhere else where more CPU/memory resources are available than on the edge computing device ECD in question). In the latter case, it is possible to provide the interpreting software function ES in a simpler version, configured to read and execute precompiled computer code. This will result in a simpler interpreting software function ES. However, in some embodiments at least one, such as at least several, substantially all or possibly even all edge computing devices ECD still feature a respective interpreting software function ES which is arranged to interpret plaintext computer code of the syntax. Whether or not each particular edge computing device ECD accepts plaintext computer code may be specified in the metadata in the database DB for the edge computing device ECD or edge computing device ECD type in question, and a central server CS may be arranged to check this metadata setting and to selectively compile or not compile the computer code distributed to each edge computing device ECD based on such metadata setting.

As mentioned above, the object data stream may be a stream of data objects, such as a stream of data objects wherein each data object represents the values of a respective tensor, which in turn may represent, for instance, a current physical state of a particular local environment sensed using one or several sensors S.

However, the data objects can be any type of data object, ranging from simple alphanumeric numeric information such as measurement values (INTs, LONGs, CHARs, etc.), over more complex data structures according to a predetermined syntax (ARRAYs, LISTs, SETs, BAGs, RECORDs, etc.). Preferably, such data structure definitions form part of the syntax of the query language. In, for instance, embedded software systems ESS, the data objects may furthermore be references to complex data objects or pointers, such as references to data objects; or callback functions.

In some embodiments, each of the objects is processed by a callback function, e.g. of an so embedded software system ESS and/or as a part of the interface IF and being executed in a defined central server CS, such as in a client application program in a central server CS, or on the edge computing device ECD. The object in question may comprise a pointer, address or other identification of the callback function.

In some embodiments, the object data stream is an endless stream of objects, calculated by the interpreting software function ES of the edge computing device ECD continuously or intermittently over time and delivered to a querying recipient via interface IF. The stream of objects may be communicated via the digital communication interface IF, for instance using callback functions, upon becoming available after the calculation or batchwise, as the case may be. Being an endless stream of objects, the calculation and delivery, for instance as invocation of callback functions, may be ongoing until something stops it, such as a request to stop the delivery of the result of the query or that the edge computing device ECD in question goes offline or breaks. Hence, as used herein, the term “endless stream” is intended to mean a stream of data objects that has no defined end point at the time of querying, but instead is arranged to produce results, for instance by callback functions, that keep on being generated (and in applicable cases the corresponding callback function or functions being invoked) until some circumstance arises that causes the generation to stop. In other words, such circumstance may be at least partly unpredictable at the time of initiation of the endless stream, requiring some kind of finishing mechanism to be activated to stop the endless stream.

In some embodiments, the syntax allows for different conditional logic-depending execution paths, interpreted and executed by the interpreting software function ES. For instance, a query defined in terms of the computer code may comprise IF-statements, WHILE loops and similar.

Hence, queries defined using the query language may be defined to continuously result in computations over and/or filtering out of measurements in a source data stream available at an edge computing device ECD receiving the query in question, and to deliver as a result data stream such as an endless data stream. Herein, such a query is denoted a “continuous so query”. In some embodiments, the present system 100, using a query language allowing such continuous queries, allows users to interactively specify continuous queries for continuously analyzing measurements flowing through edge computing devices ECD and central servers CS in real-time. As mentioned, the result of a continuous query is a real-time (possibly endless) object stream of processed/filtered measurements. The result thereby can be distributed to a consumer, such as for display to a user, by a special system callback function.

A continuous query, in contrast to a non-continuous query, will as a response deliver a data stream that is not only dependent on the state of the queried database at the time of posing the query, but that may also change over time as the internal state of the queried database changes. This is, for instance, true for a continuous query posed to an edge computing device ECD, having an internal database EDB internal state changes of which may affect the values of a data stream produced in response to the continuous query or when continuously accessing the latest reading produced by a sensor.

As an example to illustrate this aspect, a continuous query may be defined to return a stream of the position vectors of a particular edge computing device ECD, as measured every second at all times when the device ECD in question is sufficiently close to a given geo-position. In this example, the calculation involving a comparison between a measured geo-location to a predetermined geo-position is performed locally on the edge computing device ECD, which then sends the processed data as a continuous data stream to a querying peer.

Both respective stream models and user data may be stored in each individual edge computing device ECD in its object-oriented in-memory database EDB, and similarly on each central server CS (in general, any central server CS may run the interpreting software function ES, and may also comprise such an object-oriented database EDB used by the interpreting software function ES running on the central server CS). Since data stream processing at each edge computing device ECD normally involves matching in real-time fast so flowing stream objects against data in the local database EDB, the fact that the database EDB is an object-oriented database makes it possible to design the edge computing device ECD to be computationally fast in relation to its CPU power due to efficient data representation and processing. Another way of viewing this is that the object-orientation aspect of the database EDB makes it specifically adapted for efficient handling of the objects constituting the data streams the primary task of the interpretation software function ES is to process. As an example, to determine that the frequency spectrum of a measured vibration may later destroy a sensing edge computing device ECD due to material fatigue, the frequencies measured by a vibration sensor S on the edge computing device ECD in question may be matched against a local object-oriented database EDB at the edge computing device ECD of resonance frequencies of the edge computing device EDB itself.

One important aspect of the interpreting software function ES is that it may be designed to allow the combination of object streams from several different edge computing devices ECD. In other words, the interpreting software function ES may support the interpretation of “fusion queries”, that can be defined using the query language and are defined to reference several different available source streams. The interpreting software function ES is then arranged to, when interpreting such a fusion query, computationally combine the available object streams to produce a particular output object stream. An example of such a fusion query is a continuous query designed so that it, when interpreted on a particular edge computing device ECD, causes the latter to observe when several other edge computing devices ECD in a particular geographical area detect strong vibrations at the same time. A user is then alerted when this fusion query produces a predetermined result, perhaps together with a visualization in real-time of the maximum or average magnitude of the observed vibrations. The user can then interactively send new queries on-the-fly to affected edge computation devices ECD to find out details of their causes.

The query language, and in particular its syntax, may allow a query to refer to information received by a first (requesting) edge computing device 110 (see FIG. 2) from a second (responding) edge computing device 120. Such reference makes use of the above-described global namespace, and may in particular use the services of the namespace server NS to find the responding edge computing device 120 on the network NW. The contact may then be mediated by one or several intermediate central servers CS between the requesting and responding edge computing device ECD. To achieve this, it is preferred that the query language is an object-oriented query language, as described above, according to which variables can be bound to edge computing device ECD objects of different kinds and where subqueries to edge computing device ECD objects can be expressed.

Hence, a first query received by the first edge computing device 110 may include a reference to the second edge computing device 120. When interpreting the first query, the interpreting software function ES running on the first edge computing device 110 can then be configured to, as a result of the reference to the second edge computing device 120, pose a second query to the second edge computing device 120, requesting the particular information specified by the first query. The interpreting software function ES running on the second edge computing device 120 can then be configured, when interpreting the second query, to return an object stream to the first edge computing device 110, which will be used by the interpreting software function ES running on the first edge computing device 110 to calculate a result to the first query, in the form of an object stream returned to the entity posing the first query to the first edge computing device 110. In other words, the interpreting software function ES executing on the first edge computing device 110 may be arranged to cause the first edge computing device 110 to query the information from the second edge computing device 120, as a consequence of the computer code-defined query referring to the second edge computing device 120.

Instead of, or in addition to, the second edge computing device 120, the reference in the query posed to the first edge computing device 110 may be to a particular sensor S comprised in the second edge computing device 120, such as sensor S also being identified and reachable via the global namespace.

The query posed to the first edge computing device 110 may be a continuous query, as may be the case for the query posed to the second edge computing device 120 as a result of the former query. However, these two queries may be either continuous or non-continuous independently of each other, depending on the actual information sought and how the queries are defined.

Furthermore, the system 100 may further comprise a third edge computing device 130, which can be, but does not have to be, of the same type as the second edge computing device 120, in terms of what type of sensors S are available in the device and so forth.

The interpreting software function ES running on the first edge computing device 110 may then be arranged to, as a consequence of a namespace referral in the query posed to the first edge computing device 110, pose a respective query both to the second edge computing device 120 and to the third edge computing device 130. The interpreting software function ES running on the third edge computing device 130 may then be arranged to, in response to the query being received from the first edge computing device 110, generate a resulting object stream and to communicate this object stream to the first edge computing device 110 via the digital interface IF of the first edge computing device 110.

Then, the interpreting software function ES running on the first edge computing device 110 may be arranged to perform its calculation defined in the query posed to the first edge computing device 110 using both the object stream received from the second edge computing device 120 and the object stream received from the third edge computing device 130.

In general, a respective result of the queries made by the first edge computing device 110 may comprise an endless respective stream of objects received by the first edge computing device 110 from the second 120 and/or third 130 edge computing devices, calculated by the second 120 or third 130 edge computing device continuously or intermittently over time and communicated to the first edge computing device 110 via the digital communication interface IF of the first edge computing device 110.

The interpreting software function ES executing on the first edge computing device 110 can, in turn, be configured to cause the first edge computing device 110 to pose the query in so question as a consequence of the query received by the first edge computing device 110.

It is noted that the first query may comprise, as a part of its computer code definition, the second and third queries, or computer code making it possible for the interpreting software function ES executing on the first edge computing device 110 to formulate the second and third queries for communication to the second and third edge computing devices 120, 130. Then, the respective interpreting software function ES executing on the second and third edge computing devices 120, 130 can be configured to interpret the second and third computer code-defined query, respectively, and as a result deliver the respective data stream to the first edge computing device 110. Then, the second and/or third query may in turn be defined in a way referring to a fourth and subsequent edge computing device ECD and/or sensor in a corresponding manner, depending on the definition of the first query. Since the query language may support complex logic and/or contain stateful functions as discussed above, such subsequent queries may be dynamically defined on each interpreting edge computing device ECD, for instance based on parameters describing a local network NW neighborhood to the edge computing device ECD in question or other updated parameter data. This way, a single query posed to the first edge computing device 110 can give rise to an automatically developing cascade of queries, potentially involving massive numbers of other edge computing devices ECD collecting, processing and communication streams of data that eventually reach the first edge computing device 110 for processing. This also provides a very powerful way for a user to automatically deploy distributed logic to a complex system of edge computing devices ECD by basically defining the desired result, using necessary specificity, in the first query. For instance, the first query may define any other edge computing devices ECD to involve based on parameter data defined in the first query, such as particular geographic areas of interest and/or particular types of sensors S to be used. Then, the interpretation of the query may perform the actual selection of secondary edge computing devices ECD based on such parameter values and current conditions.

These mechanisms also allow the local computational power of each edge computation device ECD to be maximally exploited in a truly distributed calculation, while still providing so a robust, flexible and user-friendly system 100 which can be tailored and updated on-the-fly and in real-time. For instance, in case a user wishes to see what impact an updated query has, the updated query can simply be pushed to the first edge computing device 110, which will immediately start to interpret the updated query, including updated queries to the second 120 and third 130 edge computing devices and so on, as the case may be, ultimately producing an updated object stream back to the querying user. This updated object stream will then generally be available more or less immediately, or at least sufficiently fast so as to allow the user to perform such deployment as a part of an iterative development function, where the updated object stream constitutes feedback to the design process, in turn comprising several iteratively amended first query definitions.

With a similar goal, each edge computing device ECD may be arranged to filter out (discard) at least some, preferably substantially all, or even all, measurement data measured by the sensor(s) S of the edge computing device ECD in question, instead of storing the measurement data in its memory M, after having communicated such measurement data and/or a piece of information calculated based on the measurement data over the digital communication interface IF, such as based on an interpreted query. In other words, each edge computing device ECD may perform the measurement, perform query-defined calculations based on the measurement data and send the measurement data and/or the result of the calculations to a requesting party and thereafter purge the measurement data from the memory M. This way, an efficient data flow can be achieved throughout the system 100, without clogging the individual memories M of individual edge computing devices ECD.

As mentioned, a query of the type described herein may refer to a particular edge computing device ECD and/or to a particular sensor S of such an edge computing device ECD. However, the interpretation software function ES of a particular edge computing device ECD may also refer to a particular object stream being produced within another edge computer device ECD, such as in the form of a result from an internal calculation or, more commonly, a stream of preprocessed or raw measurement data from a particular sensor S comprised in the other edge computing device ECD.

In particular, the interpreting software function ES of the first edge computing device 110 may be arranged to accept a subscription request from an alpha edge computing device 140 for an object stream resulting from an individual query processed by the interpreting software function ES of the first edge computing device 110, in a context where the alpha edge computing device 140 did not pose the query in question to the first edge computing device 110. For instance, the first edge computing device 110 may calculate an endless stream of analyzed vibration measurements from various other edge computer devices ECD, as a result of a particular query defined within the first edge computing device 110 or posed to the first edge computing device 110 from some other peer entity. Then, the alpha edge computing device 140 may post a subscription to the resulting endless stream by requesting such a subscription via the interface IF of the first edge computing device 110. Such a subscription may be continuous or time-limited, and may of course be cancelled by the alpha edge computing device 140 at anytime.

As described above, each edge computing device ECD can be configured to have a relationship to a particular central server CS, and the two can be configured to communicate. It is generally preferred that this relationship is then a client-server type relationship, wherein the edge computing device ECD assumes a client role and the central server CS assumes a server role. This is advantageous from a security point of view, and also for being able to manage edge computing devices with limited capabilities or resources.

Hence, each of the edge computing devices ECD can have a client role in relation to a particular respective one of the central servers CS. That the edge computing device ECD has a client role means, in this context, that before an edge computing device ECD and a central server CS have established a communication connection, the central server CS cannot connect to such an edge computing device ECD. This means that the central server CS in question is not allowed to contact the edge computing device ECD. In other words, the central server CS comprises no functionality, or is not allowed access to necessary credentials, for establishing a communication link with the edge computing device ECD on the initiative of the central server CS, at least not a communication link useful for sending so or receiving computer code of the type described herein. On the other hand, an edge computing device ECD can be configured to establish communication contact with a serving central server CS, such as using credentials (login credentials, PKI key credentials, or similar). Hence, before digital communication contact has been established between the edge computing device ECD and the central server CS, it can be the case that it is always the edge computing device ECD that initiates communication with its central server CS, and never the other way around.

After such digital communication has been established between the edge computing device ECD and its serving central server CS to achieve the client/server relationship, both the edge computing device ECD and the central server CS can be configured to communicate with its counterpart in the client/server relationship, using digital communication protocols that may be conventional per se.

As discussed above, in some embodiments all communication between individual edge computing devices ECD (such as communication with other edge computing devices ECD and the below-described interactive GUI) can be configured to take place via at least one central server CS, whereby no direct contact is allowed between individual edge computing devices ECD. In some cases, at least one central server CS serving an edge computing device ECD needs to communicate with one or more intermediary central servers CS, such as higher-level central servers CS in the tree structure, in order to reach a central server CS serving another edge computing device ECD.

Using such network topology, a secure system is achieved, in which there is also no need to provide some or certain edge computing devices ECD with server functionality, saving valuable storage space.

As described above, in some embodiments the interpreting software function ES running on the first edge computing device 110 is arranged to pose a query to the second edge computing device 120, whereby the interpreting software function ES running on the second edge computing device 120 is arranged to, in response thereto, generate a stream so of data objects and to communicate this stream to the first edge computing device 110 via the digital communication interface IF of the first edge computing device 110. Then, the interpreting software function ES of the first edge computing device 110 can be configured to perform a calculation using the received stream of data to calculate a particular result.

In such a case, the interpreting software function ES of the first edge computing device 110 may be arranged to perform a preprocessing of the stream of data objects received from the second edge computing device 120, which preprocessing then results in a preprocessed stream of data objects which then forms the stream that is finally used in the calculation performed by the first edge computing device 110. In particular, this preprocessing operation may be arranged to transform the received stream of data objects so that the data contained therein adheres to a predefined global data ontology.

In general, such a preprocessing may comprise at least one of a mapping of a name standard, the name standard being local to an edge computing device ECD, to a global name standard, such as a system 100 global name standard; a measurement unit conversion; a defined data format conversion; and the application of the results of a measurement data calibration to a measurement value.

One simple example is the case in which the second edge computing device 120 internally uses a different measurement unit than what is a correct measurement unit according to the global data ontology. However, the preprocessing may also be more elaborate, such as statistically treating measurement data received in an object stream from the second edge computing device 120 so that it is stripped from statistical outliers, and so forth. In other examples, the binary data representation of the received data may be transformed to fit the global data ontology. For instance, signed four-byte integer values may be transformed to unsigned four-byte integer values.

The term “data ontology”, as it is used herein, refers to a system of definitions and/or rules with respect to measured data, specifying how measurement data is to be represented in terms of measurement units, statistical and calibration consideration standards, binary representation, etc.

For instance, fusion queries (discussed above) require the integrated data streams to be comparable even though the involved object streams may represent the same or similar data in different ways. For example, the second edge computing device 120 may represent temperature in Fahrenheit while the third edge computing device 130 uses Celsius. To be able to combine such heterogeneous data streams from different edge computing devices ECD, the interpreting software function ES, and in particular the interpreting software function ES executing on the first edge computer device 110, may be arranged to allow mediator models to be defined as queries and functions that harmonize arriving such heterogeneous object streams by transforming them to a universal model (the global data ontology). Such mediator models may be defined locally in any edge computing device ECD forming a stream server that integrate data streams from different other edge computing devices ECD. In addition to the above provided examples, such mediation may also comprise the mapping of local names of sensors S to a universally known nomenclature and calibrations of local measurements.

Hence, in the case described above, in which the first edge computing device 110 also poses a query to the third edge computing device 130, the interpreting software function ES of the first edge computing device 110 may be arranged to perform another preprocessing, now of the stream of data objects received from the third edge computing device 130. This other preprocessing may result, similarly to the preprocessing of the data received from the second edge computing device 120, in a preprocessed stream of data which is used in the calculation performed by the first edge computing device 110 instead of the data actually received from the third edge computing device 130. In a way corresponding to the previously described preprocessing, this preprocessing may also be arranged to transform the stream of data received from the third edge computing device 130 so that the data adheres to the global data ontology.

Each of these preprocessing activities may use defined parameter values to perform the preprocessing in question. Such parameter values may be different for different preprocessing operations, and in particular they may be different between data received from different edge computing devices ECD. They may be of the general type discussed above, including measurement units used and so forth. Using such parameters, that may be globally or locally defined for individual edge computing devices ECD or for defined types of such edge computing devices ECD, and that may be provided by one or several central servers CS and/or stored in individual edge computing devices ECD, a common data ontology can be automatically used or enforced throughout the system 100 even in case the system 100 encompasses many different types of diverse edge computing devices ECD, without the user having to worry about these aspects when defining her queries.

In some embodiments, the preprocessing is performed based on metadata regarding the second edge computing device 120, or regarding a specific defined type of edge computing device ECD to which the second edge computing device 120 belongs, from which the preprocessed data stream in question is received. This metadata may then be defined via the digital communication interface IF of the first edge computing device 110. In other words, information necessary to perform the preprocessing in question, for instance the preprocessing parameters, can be communicated over the digital communication interface IF of the first edge computing device 110. For instance, the first edge computing device 110 may query its central server CS for such parameters based on the global namespace identity of the second edge computing device 120, and then use received such parameters in the preprocessing of the received data stream.

In some embodiments, the digital communication interface IF of the first edge computing device 110 may comprise at least one wrapper mechanism, arranged to transform a received stream of data from an external data format to a data format internal to the query language. In other words, the second 120 and/or 130 third edge computing device can be configured to deliver the data streams to the first computing device 110 using a data format (such as a defined data structure or binary representation) which is not according to the global data ontology and/or not internal to the query language. Then, the wrapper mechanism of the first edge computing device 110 may transform the received data and wrap it into a data format directly acceptable to the interpreting software function ES running on the first edge computing device 110.

That the data format is “internal” to the query language means that it is according to a data definition provided as a part of the definition of the query language and directly useful by an interpreting software function ES without further conversion.

It is understood that the corresponding mechanism can be applied when the first edge computing device 110 receives data from a system 100 external source, or when the first edge computing device 110 receives data from a source within the system 100 but not constituting an edge computing device ECD itself. As is understood, the query language may support query definitions in terms of data collected from such “external” sources. Then, a corresponding wrapper can be defined in relation to such a data source, which wrapper is arranged to transform the received data to a corresponding query language internal data representation. This principle may in particular apply to received streams of such data.

Hence, wrapper functionality of the above discussed type may be in the form of an API that enables mapping over incoming data stream objects as they arrive in order to inject them into the interpreting software function ES kernel so that the accessed data stream can be used in continuous queries defined using the query language. The wrappers themselves may be defined as query language functions that return object streams from wrapped data sources. The system 100 may comprise a library of predefined wrappers to interoperate with common data infrastructures, such as relational databases through JDBC and data processing systems through Kafka, Azure IoT Hub, or MQTT. Using the infrastructure with wrappers, new such wrappers can easily be developed and deployed on-the-fly as new needs arise.

In order to allow cooperation between the interpreting software function ES and peripheral computer code, such as computer code not being formed from the query language but being executing on the same edge computing device ECD as the interpreting software function ES, the interpreting software function ES may comprise an external Application Programming Interface (API), arranged to allow expressions in the present query language to call such external computer code and/or arranged to allow external computer code to call expressions in the query language. “External computer code”, in this context, is intended to mean computer code not being part of the interpreting software function ES and not being computer code according to the query language, such as other software running on the same edge computing device hardware or other hardware in digital communication with the edge computing device ECD in question.

For instance, the system 100 may include a library of predefined query language function for performing various specific tasks such as math/stat computations, object stream filtering and transformation, signal processing, model and data management, and so forth. This library may be stored in one or several central servers CS or be bundled together with the interpreting software function ES in each or at least several edge computing devices ECD. The function library may be modular in the sense that it can be extended to cater for new user needs and that it is arranged so that users can define and deploy new user functions on-the-fly by simply pushing updated library information to concerned devices ECD.

However, existing algorithms and code libraries may be implemented in other programming languages, or for other reasons not be directly compatible with the interpreting software function ES. Such existing code can then be plugged into the system 100 as “foreign” query language functions (see FIG. 4a), using programming language specific APIs provided by the interpreting software function ES. Such foreign functions can then be transparently used in queries and expressions defined using the present query language. For example, in case the interpreting software function ES is implemented in Lisp and in case it is desired to use code in the C programming language as a part of the calculation of query results in an edge computing device ECD, such a C language specific API may be employed so that the interpreting software function ES can make function calls directly to the C language implemented code, resulting in that the corresponding C code is executed as a result of the interpreting software function ES performing interpretation and processing of a query.

As FIG. 4a illustrates, using the concepts of foreign functions and stream wrappers, the so interpreting software function ES can be arranged to be very extensible, in the sense that many different kinds of plug-ins can be added without changing other parts of the system 100.

“Analysis models” (FIG. 4a) are models that specify transformations, filters, computations and inferences over source data streams, producing object data streams as a result. Such analysis models may be specified by a user without requiring deep programming skills or detailed knowledge about the inner workings of the interpreting software function ES kernel to define such models. Furthermore, such analysis models may be defined using the same object-oriented query language as used to define queries of the present type (using the syntax). Hence, an analysis model may be defined as a set of query language functions and/or continuous query definitions pushed out to the edge computing device ECD via interface IF and stored in local database EDB. Thereafter, the analysis model can be used, via an API of the interpreting software function ES running on the edge computing device ECD in question, in queries posed to the edge computing device ECD.

Still with reference to FIG. 4a, “foreign functions” are functions implemented in any conventional programming language, such as C, Lisp or Java, to implement an external algorithm, such as a numerical, statistical and/or inference algorithms. Such foreign functions can be used as plug-ins, referred to in queries of the present type defined using the query language. Using a foreign function API of the interpreting software function ES, such functions can be referred to and accessed directly, via query language reference, from the interpreting software function ES without porting or modification in any other way. Such foreign functions may be precompiled and loaded into the local memory M during installation or at a later time, such as when needed. In particular, such foreign function algorithms can be used in analysis models of the above-described type to filter and transform the incoming data streams into derived object streams.

Furthermore, foreign functions can be granted access to the functionality provided by the interpreting software function ES, allowing very powerful addition of capabilities to the interpreting software function ES via such foreign functions, for example to access file systems, operating system calls, inference engines or complex database managers forming part of the kernel functionality. The foreign function API may also include the mapping of foreign language data structures to a query language data structure, so that data can be accessed directly without need for data transformation. For instance, a C language data structure can be directly mapped to a corresponding query language data structure, based on individual mapping definitions (comprised in the API) regarding simple and complex data types.

In order to access incoming data streams in continuous queries, data stream wrappers may be implemented as functions defined partly (as foreign functions) or completely using the query language. For example, the query language can be arranged with standard sensor interfaces for commonly used sensors S, available as a part of the interpreting software function ES. Only one such data stream wrapper needs to be implemented for each kind of incoming data stream; once implemented for a certain stream kind, all such streams can be queried using continuous queries of the present type. Such a data stream wrapper may then be defined as a continuous query returning an object data stream. Such a query may be defined in the form of a function, accepting arguments, for example to represent the identity of the stream it wraps.

A data stream wrapper needs to physically access an external data stream and convert each of its arriving data stream elements to a suitable data format for efficient and flexible processing by the interpreting software function ES. Different streams often represent their elements using different data structures, and data stream wrappers of the present type will therefore usually convert such external data representations to a format already supported by the interpreting software function ES. However, in some cases binary data representations can be lifted directly into the interpreting software function ES, without any data transformation. This can be done by mapping such a binary data representation to an internal binary data format specifically adapted to correspond to the known binary data format output by the sensor S in question.

The interpreting software function ES may be arranged with a built-in library of built-in data stream wrappers for common infrastructures, such as for Kafka, Azure IoT Hub, MQTT, CSV and JSON streams. In addition to this, additional wrappers may easily be downloaded, as needed, onto each edge computing device ECD and as a result form part of the interpreting software function ES effective immediately.

As described above, data streams originating from sensors S can be endless. However, data streams can also be finite. As an example, there may be a special JDBC data stream wrapper available that manages the finite result from an SQL query passed as a wrapper function parameter through JDBC to a relational database. This wrapper may then be used for persisting peer metadata in the namespace server NS.

As mentioned above and as illustrated in FIG. 4a, the interpreting software function ES may also be embeddable in a software environment present on the hardware on which the interpreting software function ES executes. This way, an embedding application or system may access object data streams produced through a continuous query API provided by the interpreting software function ES. The embedding application program or system may run in the same process and address space as the interpreting software function ES, such as when running an embedded interpreting software function ES on an edge computing device ECD having limited hardware resources. In another example, an interpreting software function ES running on a particular edge computing device ECD may function as a client to a central server CS running on some other computer or cluster communicated with via TCP or some other communication infrastructure. For instance, there may be such interfaces to embeddings defined for common infrastructures such as Kafka, MQTT, or Azure EventHub.

FIG. 4b illustrates a hierarchy of component parts in an example of an edge computing device ECD of the present type. Deeper layers are independent from upper layers. “Local database” is the local primary database EDB which exists in each edge computing device ECD as described above. In this database EDB, stream models and temporary data are stored. The local database EDB is managed by the subsystem denoted “saStorage” via interface “sa_storage.h”.

On top of “saStorage”, there are two independent interpreters (“SLOG” and “aLisp”). Module “Lisp-SLOG API” is the glue between these interpreters, making it possible to call “aLisp” from “SLOG” and vice versa.

“aLisp” is an interpreter for a subset of “CommonLisp” (a per se conventional dialect of the Lisp programming language), extended by functions required to implement the upper application layers in the edge computing device ECD, namely “sa_kernel”. “CommonLisp” is a conventional, functional programming language in which all functions return different types of (finite) objects as result. The object returned from a function is stored in the primary memory EDB, which becomes a problem in case the result is too big. Note that Lisp code is data stored in the primary database EDB. As described above, other interpretable languages can be used.

On the other hand, “SLOG” is a data stream interpreter of execution plans expressed in a language similar to programming languages such as Prolog. A “SLOG”-operator returns not an individual object, but instead the result is a handle to a stream of objects. The calling application sends a callback to the “SLOG”, applying the callback to the elements of the resulting object stream. Hence, “SLOG” operators are so-called generators, in contrast to functions in “aLisp”. Foreign object-oriented query language (“OSQL”) functions may be implemented as foreign “SLOG” operators. A foreign “SLOG” operator (that is, a foreign query language function) returns a stream of resulting objects by iteratively calling a callback function in the interpreting software IS as parameter.

External programs, such as in embedded software systems ESS, can call the edge computing device ECD kernel via API “CQ API”. The calling application can execute as a separate process on the same computer, or from a different peer or even an external entity, via some suitable communication system such as TCP. The calling application can also be in the form of one or several application threads. Thereby, the kernel guarantees thread safety. Elements of object streams can be transferred to the ESS by the interpreting software IS invoking callback functions in the embedded software system ESS.

Again, with reference to FIG. 2, in some embodiments of the present invention the system 100 further comprises an interactive Graphical User Interface (GUI), allowing a user of the system 100 to visually view and possibly also produce and modify computer code of the present type, formatted according to the syntax. This viewed computer code is computer code stored in several different of the edge computing devices ECD, computer code which uses the syntax to define several different queries using the query language. The several different queries may generally include interrelations between requesting 110 and responding 120, 130 edge computing devices defined by the queries in question as described above, also in complex query-defined cascading/tree configurations of the type discussed. The GUI can be provided on a display screen, such as on a touch screen.

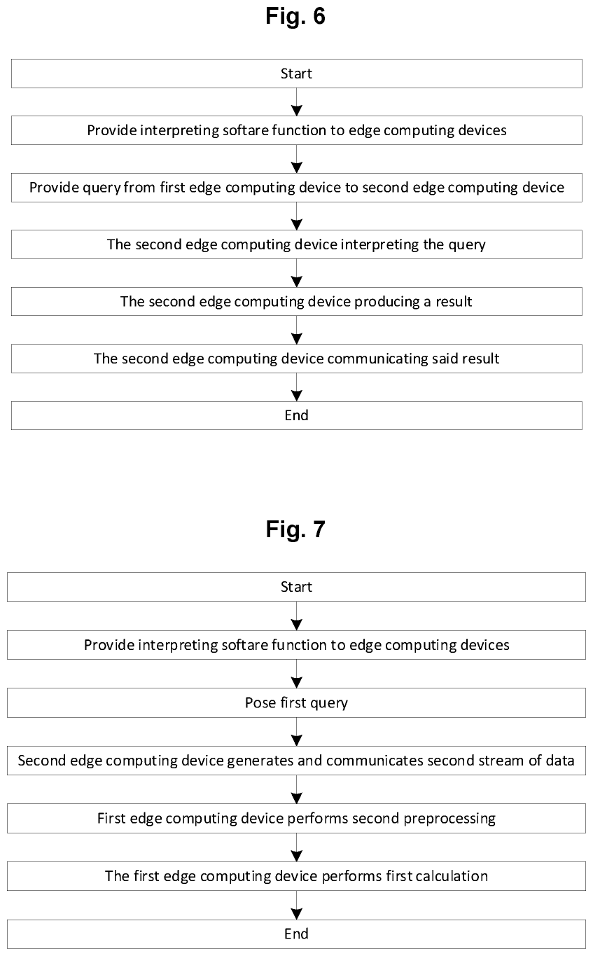

FIG. 6 illustrates a method for collecting data in the system 100.

In a first step, the method starts.

In a subsequent step, at least a first 110 and a second 120 ones of the plurality of edge computing devices ECD comprised in the system 100 are provided with a respective interpreting software function ES of the general type discussed herein, arranged to execute on the CPU of the edge computing device ECD in question and to interpret computer code of the type discussed herein, received via the digital communication interface IF of the edge computing device ECD in question and stored in the memory M of the edge computing device ECD in question. The computer code is according to a query language of the present type, having a predetermined syntax in turn being arranged to define queries the results of which can be configured to be streams of data.

In a subsequent step, a first one 110 of the edge computing devices ECD can provide to a second one 120 of the edge computing devices ECD, via the digital communication interface of the second edge computing device 120, computer code of the type defining at least one query using the syntax.

In a subsequent step, the second edge computing device can interpret the received computer code, the interpretation comprising the second edge computing device 120 performing a calculation based on a measured value from a sensor S of the second edge computing device, and the query being defined in terms of the calculation to be performed.

In a subsequent step, the second edge computing device can produce a result to the at least one query.

In a subsequent step, the second edge computing device can communicate the result via the digital communication interface IF of the second edge computing device 120 to the first edge computing device 110.

It is understood that, in this and in other embodiment examples, communication between edge computing devices ECD may in general take place via the respective digital communication interface IF of each of the involved edge computing devices ECD in the communication in question, and also via any involved intermediary central servers CS.

It is also understood that the first edge computing device 110 can be a central server CS of the above-described type.

In a subsequent step, the method ends.

FIG. 7 illustrates a method for collecting data in the system 100. Again, the system 100 comprises at least a first edge computing device 110 and a second edge computing device 120.

In a first step, the method starts.

In a subsequent step, at least the first 110 and second 120 edge computing devices can be provided with a respective interpreting software function ES of the present type, arranged to execute on the CPU of the edge computing device in question ECD and to interpret computer code of the present type, which code is received via the digital communication interface IF of the edge computing device ECD in question and stored in the memory M of the edge computing device ECD in question, according to a query language of the present type having a predetermined syntax, the syntax being arranged to define queries the results of which can be configured to be streams of data.

In a subsequent step, a first interpreting software function ES of the type, executing on the first edge computing device 110, can pose a first query of the type to the second edge computing device 120.

In a subsequent step, a second interpreting software function ES of the type, executing on the second edge computing device 120, in response to the first query being received by the second edge computing device 120, can generate a response, such as a second stream of data (the term “second stream of data” simply denoting a stream of data produced by the “second” edge computing device 120). The second edge computing device 120 can communicate this response back to the first edge computing device 110, via the digital communication interface IF of the first edge computing device ECD.

In a subsequent step, the first interpreting software function ES can perform a preprocessing (a “second” preprocessing, denoted this way since it is performed on the “second” stream of data) of the response, and the preprocessing can then result in a preprocessed second stream of data used in the first calculation. This second preprocessing can transform the second stream of data so that it adheres to a predefined global data ontology of the type described herein.

In a subsequent step, the first interpreting software function ES can perform a first calculation using the preprocessed second stream of data to calculate a first result.

In a subsequent step, the method ends.

These methods, and/or other aspects of methods as described herein, can in general be combined freely.

In the following, the processing of queries in systems 100 of the type described herein will be described in closer detail.

Generally, a query is processed by transforming and translating the query into a so-called execution plan. An execution plan is an intermediate program that, for a given query or function definition, explicitly specifies how the query is to be processed to achieve a response to the query. Specifically, an execution plan specifies a particular sequence of steps used to access data, such as in a database, to process a query.

Aspects specified by the execution plan may comprise an optimized order and/or selected strategies for accessing both system internals, external algorithms and/or data streams. For tuning the performance of queries, execution plans may be configured to be inspectable by query tuning experts, and therefore expressed on a high and human readable level. However, they are not designed for actually programming a query algorithm, i.e. making programs; rather, an execution plan can be represented as a data structure in the main memory of the edge computing device ECD. It can also be presented graphically to a user in the above-discussed GUI.

In the present system 100, execution plans can express streamed computations, in other words descriptions of high-performance computations of numerical algorithms applied on possibly endless (and possibly also continuous) streams of data flowing through the system 100. In the example of the presently described system 100, the internal execution plan language in which execution plans are expressed can be the one called SLOG (Streamed LOGic). SLOG is a very simple, but powerful, procedural algebra to represent executable procedural code over streaming data for optimized OSQL. An internal execution plan language used to define execution plans in the system 100, such as SLOG, can have one of, any combination of several of, or all of, the following properties:

Streaming: Instead of producing complete data objects, like a regular programming language, the internal execution plan language can be configured to generate possibly endless streams of bindings of variables to objects of different kinds, including strings, numbers, vectors, arrays, and even other streams. This can be achieved by not constructing complete data structures as the result from queries, but rather producing bindings of variables bound to stream elements and passed to applications through callback functions.

Filtering: The internal execution language can be configured to provide powerful logic filtering of data objects. This can be achieved by providing predicate logic-based operators as in Datalog or SQL.

Computation: The internal execution language can be configured to allow for high performance of numerical computations by at least partly being compliable to assembly instructions supported by the relevant hardware. This can be achieved by providing the possibility to declare variables and functions used in the query language to use basic hardware-oriented datatypes and instructions such as functions over numbers, arrays, or strings.

Simplicity: The internal execution plan language can be defined in terms of a small number of primitives, such as less than 10 operators that are well suited for efficient filtering and efficient computation over data streams and where at least some of the operators, in particular numerical operators, can easily be compiled into corresponding assembly instructions supported by the hardware. In the particular case of SLOG, it can be described by only five operators which are used for defining increasingly complex composed operators involving both streamed logic filtering and numerical computations.

Abstract: As mentioned, the internal execution plan language may be configured not to allow a user to write a computer program in the internal execution plan language; rather internal execution plan language programs may be configured to be represented as data structures in an internal main memory database in the edge computing device ECD. Such execution plans can be generated by a query optimizer based on the query in question. When, for instance, an OSQL query or function definition is perceived as slow, advanced users can inspect the generated SLOG algebra expressions to identify any poor optimization decisions in order to reformulate the query or instruct the query optimizer how to improve the plan.

Extensible: The internal execution language may be extensible so that new kinds of filtering and computations over data streams can be added without changing the core of the system. For this, the internal execution plan language can be configured to support foreign functions, of the general type discussed above. Such foreign functions can be implemented in some conventional regular external programming language, for instance to extend SLOG with new operators. The programmer thereby uses an API of the edge computing device ECD in question, making it possible to make computations based on so far bound variables that iteratively emit (tuples of) new variable bindings, being bound by the foreign function thus generating a stream of variables bound to objects. The API can be configured to include the possibility to influence the query optimizer, e.g. by providing costs and sizes of the results produced by the foreign functions to guide the query optimizer to reorder and transform the operators to optimize the execution speed and data requirements.

Embeddable: The internal execution plan language may be configured so that functions expressed in the internal execution plan language can be called from conventional regular programming languages used by an embedded software system ESS. The result is then returned as an object stream by the system calling call-back functions in the embedded software system ESS expressed in the regular programming language that access the objects bound to variables generated by the object stream. In the API, functions in the calling program are called back from the interpreting software function ES of the edge computing device ECD for each tuple of bound variables in the returned object stream.

As will be described in detail below, fragments of one (e.g. each) individual execution plan can be compiled all the way into binary machine-specific instructions, whereas any remaining parts of the internal execution plan language program can be interpreted.

From a general point of view, and as was described above in relation to FIG. 2, the system 100 can be highly distributed, comprising a federation of several central servers CS that manage a possibly very large number of edge computing devices ECD. The system 100 can be scaled out to manage large numbers of edge computer devices ECD by forming hierarchies of central servers CS with registered edge computing devices ECD. This is illustrated in the example provided in FIG. 5.

Each edge computing device ECD (and possibly also each central server CS) can be of one of several possible types. A “full engine” device (“Query processor”) includes all the software modules needed for query processing; whereas a “thin engine” device (“Query executor”) can only run execution plans already generated (processed) by a full engine device. Herein, the term interpretation software is used to denote such software modules configured to run query code in the ways described herein.

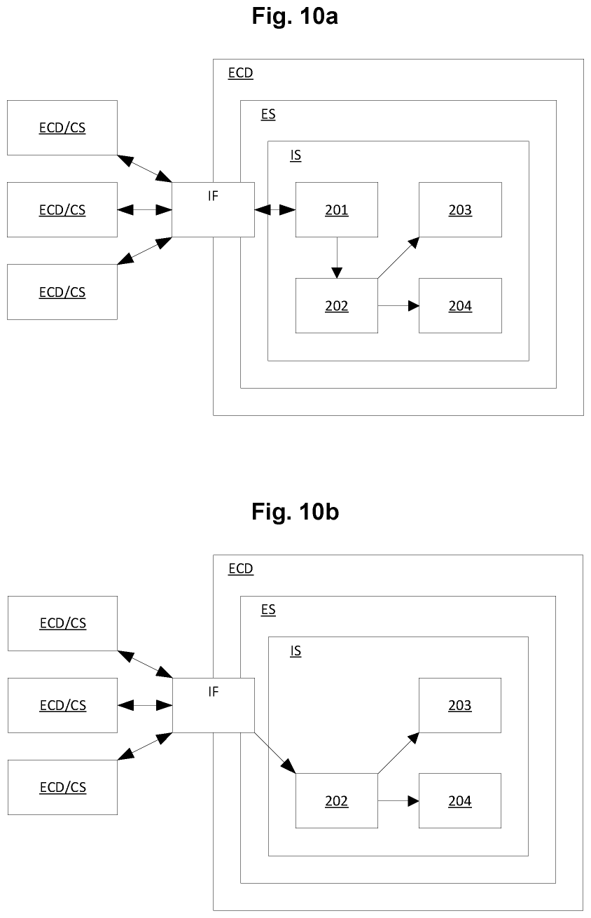

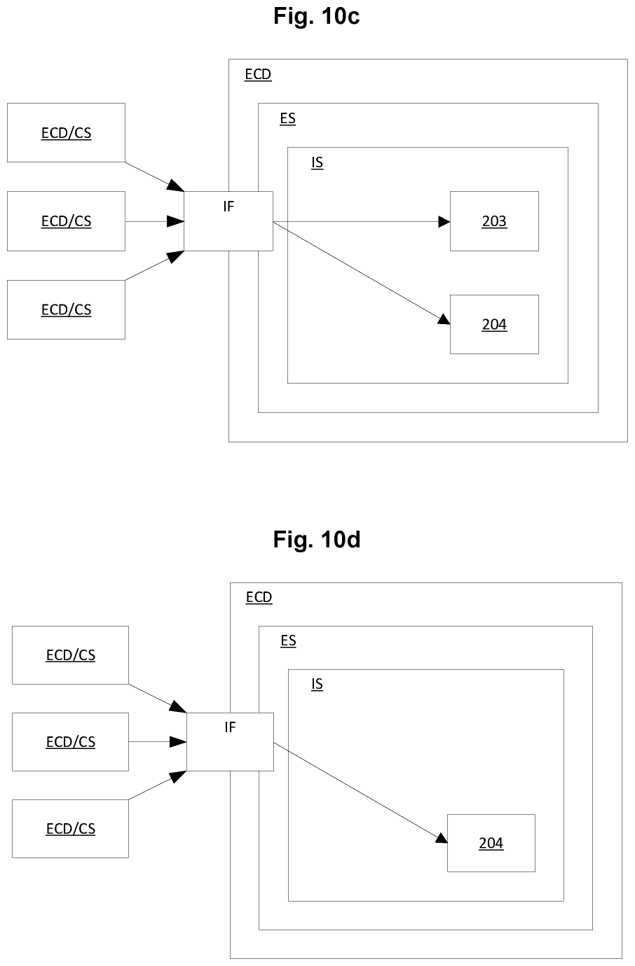

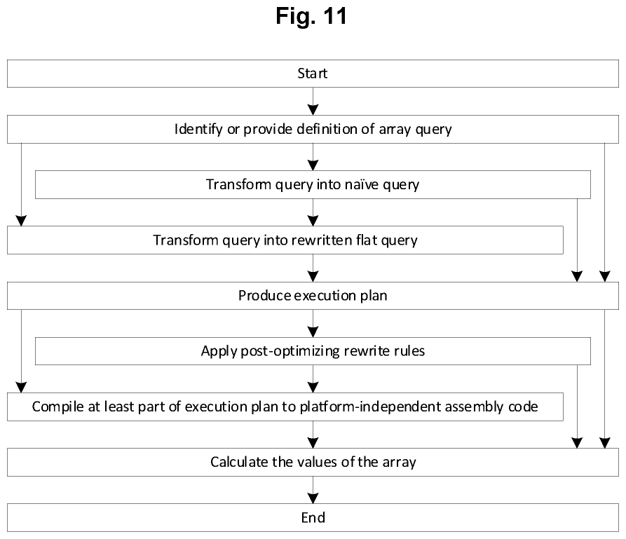

Since small edge computing devices ECD may have limited resources, such as having at the most 1 MB RAM, or at the most 512 KB RAM, or at the most 256 KB RAM, or at the most 128 KB, or even at the most 64 KB RAM, for a thin engine device, such as device with no user data stored in the local database and having no query optimizer, for instance a device as illustrated in FIG. 10b, 10c, 10d. This RAM may be a volatile (non-persistent) RAM memory, not including any non-volatile (persistent) memory such as flash memory. Small edge computing devices ECD may also have limited connectivity. As a result, they may not be able to process queries by themselves, and instead need to be configured as thin engines. Each such thin engine edge computing devices ECD may then be arranged to only be able to execute queries already optimized and compiled on a full engine device, such as on a different edge computing device ECD or a central server CS being a full engine-type device. Note that the streaming architecture of the operators used in the execution plans as in SLOG limits the amount of memory required substantially compared to materializing large query results; the latter often being impossible in small devices with limited memory. In some embodiments, central servers CS are always full engines, while edge computing devices ECD may be either full engines or thin engines. For thin engine edge computing devices ECD, the so query processing can be made in a central server CS where it is registered. A full engine device, such as the one generally shown in FIG. 10a, can be implemented using at the most 100 MB RAM, or at the most 50 MB RAM, or at the most 20 MB RAM, or at the most 10 MB RAM, or even less than 5 MB of RAM, with the corresponding definition of “RAM” as above.

Having said this, it is understood that individual central servers CS and edge computing devices ECD may run interpreting software functions ES that may or may not differ between any two entities in details, scope or functionality.

As will be described in the following, a query formulated in the present query language can be translated into a corresponding execution plan. This execution plan can then be compiled into a device-independent binary code and/or into a device-dependent binary code. Depending on hardware prerequisites on each type of edge computing device ECD, the interpreting software function ES being executed on the edge computing device ECD in question can comprise various levels of functionality.

In the simplest case, for a thin-engine edge computing device ECD that has very limited hardware specifications, the interpretation software IS can be arranged to interpret and execute a pre-compiled device-independent binary code, entailing translating each such binary instruction into a corresponding device-specific machine code instruction. There may also be thin-engine edge computing devices ECD that can only execute precompiled device-specific binary code, but in that case the system 100 can be configured to also comprise edge computing devices ECD arranged to interpret code as opposed to merely executing it.

For thin-engine or full-engine edge computing devices ECD having more powerful hardware specifications, the interpretation software IS can, in addition to interpreting device-independent binary code of the type, also interpret and execute non-compiled execution plans.

For full-engine edge computing device ECD having even more powerful hardware specifications, the interpretation software IS can, in addition to interpreting device-independent binary code and non-compiled execution plans, also interpret and run query-language queries of the present type.

The system 100 can comprise zero, one or several of each of the above types of thin-engine and full-engine edge computing devices ECD.

FIGS. 10a-10d provide an overview of various alternatives.

FIG. 10a illustrates select parts of an exemplary full-engine edge computing device ECD. As explained above, the edge computing device ECD comprises an interface IF via which it can receive queries, non-compiled execution plans, machine-specific assembler code and/or machine-independent assembler code from peer edge computing devices ECD and/or central servers CS. After processing of queries, such as producing a compiled or non-compiled execution plan from a query, the edge computing device ECD can send the results of such processing to one or several peer edge computing devices ECD and/or central servers CS. The edge computing device ECD comprises the interpreting software function ES, that in turn can comprise the interpreting software IS. The interpreting software IS, in turn, comprises a module 201 arranged to interpret non-compiled query language code of the present type, and possibly arranged to produce compiled and/or non-compiled execution plan code of the present type. Module 201 can hence interpret, run and possibly at least partly translate and/or compile an incoming query. The interpreting software IS can also comprise a module 202, arranged to interpret and run non-compiled execution plan code (such as SLOG code). The interpreting software IS can also comprise a module 203, arranged to interpret and run platform-independent assembler code (such as SLAP code, see below). The interpreting software IS can also comprise a module 204, arranged to execute platform-specific assembler code, such as by invoking a loader. Since the code defining the query to be run by the edge computing device ECD can comprise elements from each of the code abstraction layers (query language code, execution plan code, machine-independent assembler code, machine-specific assembler code), the modules 201, 202, 203, 204 can be configured to communicate among each other so that the correct module so handles the correct part or parts of the query in question. Specifically, module 201 can be arranged to push execution plans to module 202 for processing; whereas module 202 can push assembler code to modules 203 and/or 204 for processing. Any work product, such as an execution plan or compiled parts, can be distributed back, via interface IF, to other edge computing devices ECD and/or central servers CS.

FIG. 10b illustrates a first exemplary thin-engine client edge computing device ECD, not comprising the module 201, but instead arranged to process, using modules 202, 203, 204 as described above, execution plans and machine-independent/machine-specific assembler code. Any compiled assembler code produced can be distributed back, via interface IF, to other edge computing devices ECD and/or central servers CS. Otherwise, the edge computing device ECD of FIG. 10b can be configured to function in the same manner as the one of FIG. 10a.

FIG. 10c illustrates a second exemplary thin-engine client edge computing device ECD, corresponding to that of FIG. 10b but not comprising module 202. The client edge computing device ECD of FIG. 10c can hence interpret and run assembler code in modules 203 and 204, but not perform any compilation the results of which can be distributed back.

FIG. 10d is similar to FIG. 10c, but illustrates a third exemplary thin-engine client edge computing device ECD that also does not comprise the module 203.

It may be the case that all queries and models cannot be, or are not, completely compiled into binary instructions. For this and possibly other reasons, in some embodiments the respective interpretation software IS of all, at least most, or at least several, of the edge computing devices ECD can be arranged to interpret execution plans that are at least not completely compiled, in order to interpret execution plan fragments that have not been translated into binary code. In such cases, the execution plan compiler (query processor) can be configured to identify the code fragments in an execution plan that it can compile, and then to generate binary code for those compiled execution plan fragments while leaving the rest to the interpreter. The execution plans may thus, in such cases, contain both internal execution plan language code and pointers to binary code fragments.

Alternatively, in some embodiments the interpretation software IS of all, at least several, or at least one, of the edge computing devices ECD can be configured to not contain a query processor. Instead, a query executor for assembly code (such as SLAP code, again see below) may be provided, so as to interpret any compiled machine-independent assembly code forming part of the query passed to the device in question.

In both these alternatives, some (but not all) thin engine edge computing devices ECD of the system 100 may also be configured to not be provided with an interpreting software function ES at all, but be arranged to only receive queries in the form of compiled, platform-specific binary code, invoked by a loader.

One advantage of the presently described system 100 is that it can be configured to enable full interactivity for an operating user, such as via the GUI. All optimizations and compilations should preferably be executed without delay after a query or function definition has been defined.

To achieve this, the compilation time should preferably be minimized, so as to guarantee immediate execution of defined or updated queries without any noticeable delays for the operating user. Moreover, since memory is often very limited on thin engines, the generated code size should preferably be minimized. Considering such thin engines' often slow processing speeds, the generated code should also preferably be as efficient as possible.

The compilation and optimization of queries should also take into consideration that both edge computing devices ECD and central servers CS in (a federation of) the system 100 may have different hardware and/or operating system architectures. Namely, the system 100 architecture should be able to manage distribution of the code to all different kinds of peers in a federation, and to this end it should be possible to ship code for different architectures around the federation in question.

Furthermore, some edge computing devices ECD and/or central servers CS may miss certain functionality. For instance, some devices may not support the generation of binary code (as is the case, for instance, for OS X devices). The system 100 may then comprise functionality to compensate for such missing functionality in different edge computing devices ECD and/or central servers CS.

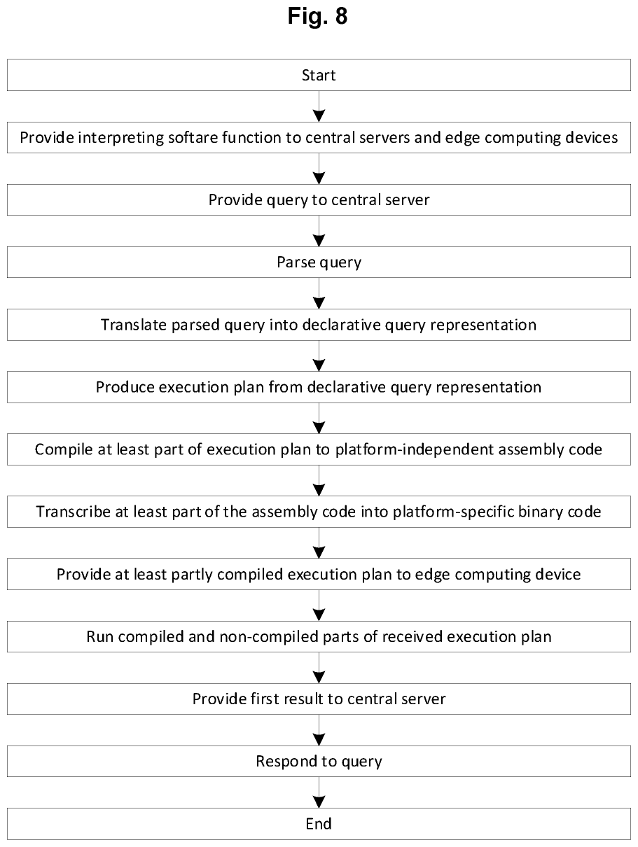

FIG. 8 illustrates the steps of a method for query processing in the system 100, the system 100 being arranged to perform the steps. As mentioned above, the method is also for distributing and deploying software functionality across the system 100.

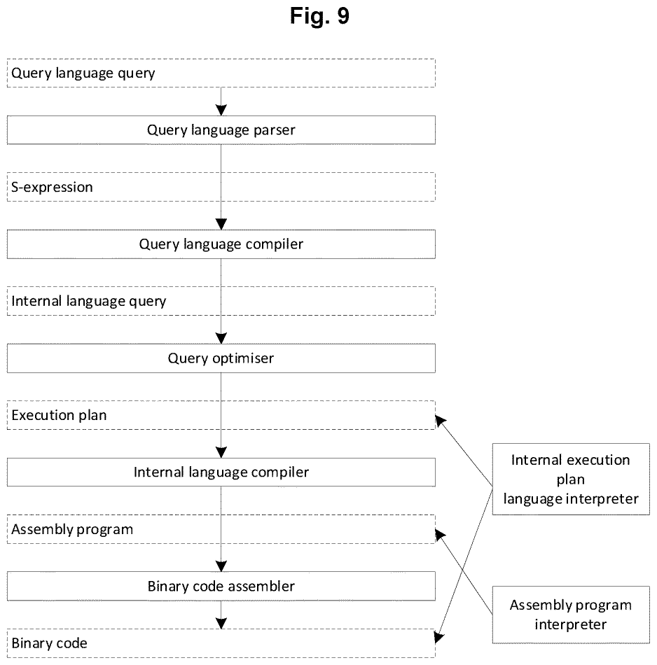

FIG. 9 illustrates the information flow and process from the point of view of acting entities (software modules of the interpreting software function ES of a central server CS) and data on which the acting entities operate.

It is noted that all intermediate representations of information indicated in FIG. 9 are inspectable for tuning experts.

In a first step, the method starts.

In a subsequent step, if this has not already been performed, the interpreting software function ES of the presently described type can be provided to one or several central servers CS and/or one or several edge computing devices ECD.

In a subsequent step, a central server CS can accept, from a querying party and via the digital communication interface IF, a query of the present type. The querying party may be a different central server CS, an edge computing device ECD or any external entity using the API of the central server CS to pose the query. As noted above, the query can be defined so that the results of the query in question are streams of data objects, at least one of which streams can be an endless stream of objects as discussed above, calculated based on data measured by the sensor S of an edge computing device ECD. The results may then be provided continuously or intermittently over time and communicated via the digital communication interface IF as will be described in the following.

In particular, the received query can be defined according to a query language of the present type, having a predetermined syntax, the syntax being arranged to define queries the results of which can be configured to be streams of data, and to allow the query to be defined in terms of a calculation to be performed based on a measured value from the sensor S.

The query language may be an OSQL (object-oriented) query language.

To illustrate the principles of the processing of such queries, the following example is provided, in the form of an OSQL function whose task it is to find a stream containing the prime numbers smaller than n:

```
create function primes(Integer n)−>Stream of Integer m
  as select m
    where notany(select factor
          from Integer factor
        where mod(m,factor) = 0
            and factor in range(2,sqrt(m)))
      and m in range(2,n)
```

Note that the select expression in the body does not state in what order functions and filters should be evaluated; it merely states desired properties of the resulting stream of integers. It is up to the query processor to automatically generate an optimized executable program that computes the stream of prime numbers.

Furthermore, OSQL functions can be defined in terms of variables of arbitrary domains, such as integers, vectors, matrices, strings, etc., which facilitates definition of queries and functions involving numerical computations.

An OSQL query is regarded as an anonymous (lambda) function without arguments, which is executed immediately after it is defined. For example, the following OSQL query (defined to find the stream of numbers between 1 and 10 whose square root is smaller than 10):

select Stream of i from Integer i
where i in range(1,10) and sqrt(i) < 10

can be processed by generating the following anonymous lambda function:

```
create function lambda( )−>Stream of Integer
  as select i from Integer i
    where i in range(1,10) and sqrt(i) < 10,
```

and then immediately calling lambda( ).

In a subsequent step, the interpreting software function ES of the central server CS can parse the received query, to produce a parsed query expression.

The query received by the central server CS may be in textual (plaintext) format, or be easily transformed into such format, by for instance unpacking and/or decrypting the query.

The first step of query processing can hence be to textually parse the query into an equivalent syntax for further internal processing. Such equivalent may be a so-called abstract syntax tree, for instance an S-expression.

An abstract syntax tree is generally a data tree representation of the abstract syntactic structure of text, such as source code, the text being written in a formal language. Each node of the tree denotes a construct occurring in the text.

An S-expression (or “symbolic expression”) is generally an expression in a like-named notation for nested list (tree-structured) data. In the usual parenthesized syntax of Lisp, an S-expression may be defined as:
1. an atom, or
2. an expression of the form (x.y), where x and y are S-expressions.

More concretely, an S-expression can be viewed as a Lisp program that can be immediately evaluated. The evaluation of the S-expression may result in the execution of at least some of, such as all of, the succeeding query processing steps described below to evaluate the originally received query. The use of S-expressions enables representing OSQL in Lisp code that can then immediately be executed or shipped to other peer devices for remote evaluation (i.e. transmission of the executable software code from the central server CS to a remote computer entity for subsequent execution, and the subsequent returning of the results of the execution back to the central server CS).

An S-expression for (equivalent to) primes( ) looks like this:

```
(create-function primes ((integer n)) ((stream of ((integer m))))
  as (m)
  where(and (notany (select (factor)
      foreach((integer factor))
      where (and (= (mod m factor) 0)
        (= (in (range 2 (sqrt m)))factor))))
    (= (in (range 2 n)) m)))
```

In a subsequent step, the parsed query can be translated, by the interpreting software function ES of the central server CS, into an equivalent query in a declarative object-oriented query representation based on predicate logic. A “declarative” representation is one that defines the logic of a computation without specifying its control flow. A “predicate” is a logics symbol which represents a property or a relation. For instance, in the first order formula P(a), the symbol P is a predicate which applies to the individual constant a. Similarly, in the formula R(a,b), R is a predicate which applies to the individual constants a and b. Predicates may be interpreted as relations. For instance, in a standard semantics for first-order logic, the formula R(a,b) would be true on an interpretation if the entities denoted by a and b stand in the relation denoted by R.

In some embodiments, the declarative object-oriented query representation may have strong typing of various kinds of objects, such as tensors, functions, data generators, and so forth. “Statically typed” languages (such as C and C++) have strict typing rules that allow the compiler to determine the type of an expression at compile time, in contrast to “dynamically typed” (or “late binding”) languages (such as Lisp and Python), where the type of each object has to be determined at run time. The present inventor has successfully used a declarative object-oriented query representation extending Datalog (a declarative logic programming language being a subset of Prolog). However, the bottom-up query processing of Datalog is not suitable for data streams since it materializes large data objects to produce full query results, while data streaming instead produces stream of variable bindings to small transient objects passed to callback functions in applications.

In some embodiments, the declarative object-oriented query representation may require foreign function definitions to also correspond to an inverse foreign function definition, or to support such definitions.

An exemplary extension of a conventional language such as Datalog is primitives for defining user-defined predicates in terms of multi-directional foreign functions (i.e. functions which may be called with several different function inverses depending on what arguments and results are bound or unbound, called binding patterns, in the form of foreign OSQL functions defined in some external programming language, such as Lisp, C, or Java. See T. Risch, et. al., “Representing Matrices Using Multi-Directional Foreign Functions”, published in Gray, et. al., “Functional Approach to Computing with Data”, Springer, ISBN 3-540-00375-4, 2004. For example, a call to the function sqrt(Real x)->Real y in a query select sqrt(4) requires the computation of y as the square root of x=4, i.e. x is bound and y is unbound. However, in the query select x from Number x where sqrt(x)=2, y=2 is bound and x is computed as y². In the query select sqrt(4)=2, both x and y are bound and the query optimizer will then choose an execution plan testing the 2²=4, which is cheaper than testing that 2 is the square root of 4.

Thus, using multi-directional foreign functions, a programmer has the option to implement not only the function in the chosen external language, but also its inverse. For example, the inverse of the foreign function sqrt(Real x)->Real r is r². This may substantially improve the performance of queries using the foreign function, since it allows the query optimizer, in the subsequent step of defining the execution plan, the choice between the function and its inverse to bind variables. By defining inverses to functions, the query optimizer is given more choices for optimizing queries, since it can bind more variables by applying such inverses. Without knowing that the inverse of y=sqrt(x) is x=y², the entity processing the query will have to test for every possible value of x whether sqrt(x)=4. If there are a million possible values of x in the database, by knowing the inverse, a single multiplication 2*2 can be performed instead, which is a million times faster.

Hence, the declarative query representation may include such a multi-directional (or at least bi-directional) function.

In some embodiments, the declarative object-oriented query representation may require or support the use associated cost functions (cost models) for foreign function definitions.

In the presently described translation into an equivalent query, the interpreting software function ES of the central server CS may use type inference (in general, the term “type inference” refers to the automatic detection of properties of an expression in some language) to determine the types of variables occurring in the parsed query. The use of a predicate logic-based representation, such as OSQL queries, enables powerful logic-based transformations in the subsequent definition of the execution plan. Such transformations may be used to simplify and optimize the query, to produce equivalent smaller and faster queries. However, the query representation may not be sufficient by itself for efficient query execution, so the subsequent query optimization steps may need to be supplemented with information from the original query along with data statistics, and knowledge about functions such as statistics about their execution costs, sizes of results and how large percentage of possible input arguments produce non-empty results to automatically choose a good strategy for the execution plan.

In the current example, the parsed and type-checked OSQL is transformed into a rewritten OSQL expression. The rewritten OSQL representation of the above function definition looks like this:

```
create function primes(Integer n) −> Stream of Integer
  as select m
      from Integer m, Bag of Integer _v5
    where _v5 = makestream(
        (lambda (Integer m) −> Integer
          as select factor
              from Integer factor, Real _v2,
                Integer _v4
            where 0 = mod(m,factor)
              and _v2 = sqrt(m)
              and _v4 = _cast_integer(_v2)
              and factor in iota(2,_v4)),
        m)
      and notany(_v5)
      and m in iota(2,n);
```

OSQL is both a relational and a functional query language where OSQL functions are defined in terms of declarative queries (“select” expressions) where the inputs and outputs of the functions are indicated by the -> notation in the functions' head. In OSQL, functions are defined with a logical direction and producing results based on bound arguments. In order to run a given OSQL query, additional knowledge is required regarding, for instance, inverses of functions, algebraic formula transformations (rewrites) and cost models for foreign functions. It is realized that OSQL is one possible example of a useful relational language, and that other relational languages having one or more of the properties described here in relation to OSQL can be used instead.

In the above-discussed prime number example, the query optimizer may perform type checking and unfold nested function calls into rewritten queries. Furthermore, it may generate a binding of the variable v5 to a stream of integers represented by an anonymous lambda predicate applied on the parameters m and v7. Here it is noted that testing the predicate 0=mod(n, factor) requires the variables n and factor to be known, and calling makestream( . . . ,m) returns the stream of integers requires of the variable m to be bound, so the where-condition cannot be executed as it looks. The query optimizer will, however, produce an executable program in the form of an execution plan.

Namely, in a subsequent step the interpreting software function ES of the central server CS can produce an execution plan corresponding to the above-discussed parsed, optimized and possibly compiled query expression, whereby the execution plan defines at least one calculation to be performed based on a measured value from the sensor S of the edge computing device ECD. It is understood that this definition may be explicit (e.g. explicitly referring the sensor S and/or the edge computing device ECD in question) or implicit (i.e. the identity of the sensor S being inferred from other information in the query or externally provided to the central server CS and/or the edge computing device ECD, or dynamically determined on-the-fly, at run-time, based on current parameter values).

To this end, SLOG (as characterized above) can be used, or an alternative internal execution plan language with one or more of the above-described properties can be used.

As explained above, the non-procedural logic-based query representations do not specify what algorithms (i.e. foreign functions) to use and in what order the elements of the result stream or set is produced. In this and in other situations, therefore, responding to a query or calling a function requires the query optimizer of the interpreting software function ES of the central server CS to choose a good execution strategy.

Cost-based query optimization (the practice of determining a most efficient way to execute a given query by considering a set of possible query plans) is useful for the present purposes to produce an execution plan based on data statistics and other knowledge about operators in queries and data stored in a memory database of the central server CS. Query optimization is used for producing an efficient and executable execution plan. This may be important since a poor execution plan may be thousands of times slower than the optimal or even not executable.

As described above, the execution plan may be expressed using the internal execution plan language, which in particular for OSQL queries can be SLOG. Hence, for a given OSQL function, the query optimizer of the central server's CS interpreting software function ES can generate an optimized stream generator in SLOG that implements the function in question. The optimization can be guided by (based on) a query cost model that estimates the cost of calling a stream generator based on optimization metrics of the operators and algorithms used in it. A stream generator is a predicate extended with binding annotations indicating what variables are inputs and outputs in a predicate, respectively. When executed, a stream generator will generate a stream of bindings for the output variables, given that the input variables are known. For example, the function primes (Integer n)->Stream of Integer m will produce a stream of bindings of variable m to prime numbers smaller than n.

SLOG is an example of a very simple but powerful language for representing execution plans for OSQL as stream generators. It has only five built-in operators, namely “call” (call to foreign stream generator), “funcall” (foreign function call), “and” (conjunction), “or” (union), and “or!” (conditional union). In addition to the five system operators, the user can implement stream generators by APIs to some external programming languages. The system may comprise and support a library of predefined stream generators that can be used directly by the programmer.

The following are some examples of SLOG algebra expressions generated for some exemplary OSQL queries.

The following SLOG stream generator is produced for function primes( ) by the query optimizer:

```
Primes−+(Integer n, Integer m)
  as select m
      from Integer m, Stream of Integer _v5
    where call(range−−+,2,n,m)
      and _funcall(makestream(
        (lambda−+ (Integer m, Integer factor)
          as select factor
              from Integer factor, Real _v2,
                Integer _v4
            where funcall(sqrt,m,v2)
              and funcall(cast_integer,_v2, v4)
              and call(range−−+,2,v4,factor)
              and funcall(mod,m,factor,0)),
        m, v5)
      and notany(_v5)
```

Here, the test funcall(notany, v5) calls the foreign function notany(v5) that succeeds when it returns true if the stream _v5 is empty.

Here, a stream generator in the SLOG execution plan is generated by annotating the previous OSQL query predicate with a binding pattern that indicates that the parameter n must be bound for it to be applicable and produces a stream of bindings to m. A binding pattern is a string where a ‘−’ indicates that a variable has to be bound to some value and a ‘+’ indicates that the variable is going to be bound by invoking the stream generator. In general, SLOG stream generators produce zero, one or several bindings of unbound variables for the given bound ones. For example, the invocation of range−+(2,v5, factor) when v5 is bound to 3 generates an object stream of bindings of variable factor to each of the integers 2 and 3. A common case is stream generators generating a single value, called pure foreign functions. For example, the pure foreign function sqrt(x) computes the positive square root of x, and the foreign function call funcall(sqrt,m1,v2) binds v2 to 2 if m1 is bound to 4.

Queries may produce anonymous (lambda) stream generators, for example:

```
lambda+(Integer i)<−
  call(range−−+,1, 10, i) and
  funcall(less,i,5)
```

Hence, as a result of this step an execution plan is established, being equivalent to the query received (defined using the query language), the execution plan defining an efficient way to produce a response to (a result for) the query.

In a subsequent step, a part of the interpreting software function ES of the central server CS being an internal language compiler may then compile at least part of the resulting execution plan by converting the at least part of the execution plan to corresponding platform-independent assembly code (“assembly program”, defined in an assembly program language).

It is noted herein that the term “assembly program language” refers to a symbolic machine code language generally using one statement per machine instruction. However, the assembly program may be defined in a platform-independent manner, independent of specific hardware and/or operating system requirements or functionality that may exist on the edge computing device ECD that is to execute the corresponding binary machine code (see below). The assembly program can be defined as binary or plaintext code. The assembly program can be translated into binary code for a specific computer architecture by a binary code generator for the specific computer architecture.

In some embodiments, at least part of the resulting execution plan is, however, not compiled, but kept as non-assembly, non-binary code to be interpreted by the interpreting software function ES of the edge computing device ECD.

As a result of the compilation into assembler code, the performance of an execution plan produced in the general way described above, by the query optimizer, is further improved. Continuing the example using SLOG as the internal execution plan language, the SLOG compiler can translate SLOG stream generators of the above-described type into an assembly program language, such as the one called SLAP (SLog AssemblyProgram).

In general, a machine-independent assembly language can be used as the assembly program language. SLAP is an example of such machine-independent assembly language. When compiling execution plans into such assembly language, some further code generation optimizations methods can be applied to improve execution speed and minimize code size, such as removing unnecessary jumps, optimizing register allocations, peephole optimization, and dead code elimination.

In some embodiments, where there is no binary code generator implemented for some computer architecture or if it is not allowed to generate binary code for some architecture (such as OS X), an abstract code (e.g. SLAP) interpreter of the interpreting software IS can be used to interpret the assembly program.

In some embodiments, the internal execution plan language is of a type that the interpreter function of the edge computing device ECD can directly interpret in case internal execution plan language statements are not compiled. This is, for instance, the case in the exemplary system 100 described herein, using SLOG as the internal execution plan language and SLAP as the assembly program language.

Hence, the established execution plan, defined using the internal execution plan language, needs in this case not be completely compiled into the assembly program language, since it can also be directly interpreted by the interpreting software function ES. Therefore, the (e.g. SLOG) compiler can generate (e.g. SLAP) assembly program language code fragments for the (e.g. SLOG) expressions that it can compile (into e.g. SLAP), while the interpreting software function ES handles the remaining (e.g. SLOG) code, that cannot be further compiled or for which compilation is deemed not to pay off, by interpretation.

For example, the compiler may be configured not to compile objects whose types cannot be statically determined; and/or operations and operations that the compiler does not support, such as string operations, iterations over bags and streams, data conversions etc., as the case may be. Normally, it does not pay off to compile costly operations not supported by machine instructions, such as FFT (Fast Fourier Transform); image recognition; and advanced numerical array computations. Such operators can instead be implemented as interpreted calls to regular foreign functions.

Continuing the above example of primes, the SLOG code with SLAP code fragments will look like this:

```
primes−+(Integer n, Integer m)<−
  select m
      from Integer m, Stream of Integer _v5
    where call(<code1>, n, m)
    and funcall(makestream, (lambda−+(Integer m1,Integer factor)<−
        call(<code2>, m1, factor)), m, v5)
    and funcall(notany, v5)
```

Since the SLOG code in the body of the inner anonymous (lambda) stream generator contains only defined types (Integer and Real), and only arithmetic operations, it can be fully compiled into SLAP code in <code2>. The SLAP code in <code1> implements a loop producing the integers between 2 and n.

In a subsequent step, a binary code assembler part of the interpreting software function ES of the central server CS may transcribe at least part of the assembly program into platform-specific binary code. This process of transcribing may in its entirety be comprised of a simple statement-by-statement translation of the assembly statements of the produced platform-independent assembly program into the corresponding platform-specific binary statements for the particular hardware/operating system platform that the execution plan is intended to be executed on.

The binary code assembler (such as a SLAP assembler) of the interpreting software function so ES of the central server CS may produce binary codes (statements) for one or several of the target architectures supported by the system 100, so as to produce a code bundle of binary codes for one or several different architectures. Both the platform-specific code bundles and the platform-independent (SLAP) code can be saved in the database of the central server CS for later re-use. To produce platform-specific binary code for different kinds of edge computing devices ECD, specific binary assemblers, such a specific SLAP binary assemblers, can be made available for each supported target architecture. A code bundle can also contain several kinds of assembled binary machine code, which is then called from (executed as initiated by) the interpreter on the target machine (the edge computing device ECD in question) at run time.

The machine-specific binary code can be assembled on the fly into the target machine architecture and saved in the database of the central server CS in direct connection to when the code is (to be) sent to an edge computing device ECD for query processing. If the code is executed in a central server CS, it can be immediately assembled to the native machine code of the central server CS.

As an alternative to binary code, the binary code assembler may also produce platform-specific assembly program code. In this case, such assembly code can be efficiently byte code interpreted in edge computing devices ECD the machine architectures of which do not allow just-in-time compilation. This is for example the case for OS X.

Continuing with the SLOG/SLAP example, the following are illustrative statements in different platform-specific formats (apart from the first line, showing the corresponding platform-independent SLAP statement):

| | |
|---|---|
| dadd D2,D3 | ; SLAP assembly instruction |
| addsd xmm2,xmm3 | ; Intel x86-64 assembly instruction |
| fadd D2,D3 | ; ARM Aarch64 assembly instruction |

The binary code assembler can allocate the available registers of the target architecture, place the rest of the operands on the stack (SLAP typically has more registers than physical devices), and transcribe each instruction one-to-one.

Any parts of the execution plan that is not compiled into assembly code and/or that is not transcribed into platform-specific assembly/binary code can be interpreted by the edge computing device ECD interpreting software function ES. Any compiled and transcribed binary code parts of the execution plan can instead be directly executed by the processor of the edge computing device ECD.

In case the entire execution plan can be compiled into assembler, there is even no need for an execution plan interpreter on the edge computing device ECD, which saves storage space (both RAM and flash) on the edge computing device ECD. In such cases, the central server CS may determine whether a particular query definition needs the execution plan language interpreter function to be installed on the edge computing device ECD in order to run a given query or calling a function, and, if this is the case, initiate the automatic downloading and installation of such function on the edge computing device ECD in question if not already installed.

In some embodiments, at least for one, such as several, edge computer devices ECD in the system 100, the edge computing device ECD in question is capable of both interpreting the internal execution plan language code and executing at least one of compiled assembly code and transcribed binary code. Furthermore, in some embodiments at least part of the execution plan definition is compiled whereas at least part of the execution plan is not compiled.

In a subsequent step, at least one of the edge computing devices ECD can then receive, via its digital communication interface IF, the execution plan produced as described above, that can be non-compiled, at least partly compiled or completely compiled.

In a subsequent step, the interpreting software function ES of the at least one of the edge computing devices ECD, executing on the CPU of the edge computing device ECD in question, runs both any compiled and any non-compiled parts of the at least partly compiled execution plan, as the case may be, to produce a first result to the at least partly compiled execution plan. The interpretation comprises the performance of the above-described calculation based on the measured sensor S data.

From the above it is clear that this running may be performed on one single edge computing device ECD; on several edge computing devices ECD in parallel; and/or in a multi-layered set of edge computing devices ECD reporting to each other according to a tree structure of such edge computing devices ECD. Typically, this will be defined directly in the parsed query.

As has been illustrated and explained above, any non-compiled parts of the execution plan can be run by the interpreting software function ES of the edge computing device ECD interpreting the execution plan parts in question; whereas any compiled parts of the execution plan can be run by the interpreting software function ES of the edge computing device ECD initiating their execution directly by the CPU of the edge computing device ECD.

In a subsequent step, the edge computing device ECD can communicate the result of the run execution plan (the first result, which is then an endless stream of objects as described above) via its digital communication interface IF to the central server CS.

In a subsequent step, the central server CS, in reaction to the reception of this result from the edge computing device ECD, can communicate the results of the query, or a secondary result being calculated based upon the results received from the edge computing device ECD, to the querying party in question. This then constitutes a response to the posed query.

In alternative embodiments, the edge computing device ECD may communicate the results to a different entity, such as a different central server CS or a different edge computing device, as may be specified (or implied) as a part of the query. Correspondingly, in case the central server CS receives the results, it may provide the querying entity with the results (or the secondary results) to a different entity than the querying one.

The system 100 may be configured so that any system peer edge computing device ECD and/or central server CS that receives a query from any entity can request immediate full query processing of such received query by its parent central server CS. The parent central server CS can then be configured to, in response to such request, perform the steps described above to produce an at least partly compiled execution plan that is shipped back to the requesting child entity (the recipient of the query). This shipped execution plan can then contain only the platform-specific binary code for the particular hardware and/or operating system of the requesting child entity (along with any non-compiled parts of the execution plan). It can also contain platform-independent binary code as described above. The parent central server CS may be configured to store the compiled and non-compiled parts of the execution plan in its database for later use by similarly or differently configured edge computing devices ECD.

The presently described system 100 can generally be designed to minimize unnecessary work and to keep thin engines (edge computing devices ECD) as simple as possible. This can be achieved while keeping the possibility of full functionality for full engines. Also, by sending queries for optimization and compilation to some other peer in the federation producing an execution plan and/or binary code for execution on the peer, thin engines can be operated using a broad functionality spectrum.

Hence, the internal language compiler can be configured to only or at least in part compile arithmetic parts of the internal-language execution plan and to leave remaining predicates as they are for the interpreting software function ES to interpret at the edge computing device ECD. The internal language compiler can hence be configured to replace the compiled predicates with one CODE object per group of adjacent predicates.

In some embodiments, the internal language compiler can be configured to compile the execution plan into the platform-independent assembly program and thereafter to save the assembly program, such as in the database of the central server CS. Then, in case an additional edge computing device ECD is called upon to process the same query, or part of the query, the saved assembly program can be quickly transcribed, by the same or a different central server CS, into binary code specific to whatever hardware and/or operating system platform the additional edge computing device ECD has. The saved assembly program (such as SLAP code) can be stored in a shared manner in the system 100, such as shared among peer central servers CS for re-use on a system 100 wide level. This saves the internal language compiler from having to compile the same execution plan several times for different machine architectures; the transcribing is typically much faster than the compiling. The platform-independent assembly program can also be interpreted on one or several edge computing devices ECD as described above.

Furthermore, using the above-described methodology, the central server CS may be configured to only transcribe the platform-independent assembly program into platform-specific machine code when necessary, and then to retain (cache) the resulting platform-specific binary code for later re-use.

Since transcribing typically is a very inexpensive operation, it can be configured to be performed on the fly, such as even while (as a part of the) sending the execution plan to a peer central server CS or to an edge computing device ECD.

Also, the platform-independent assembly language, such as SLAP code, can easily be made portable and efficient both in code size and interpretation time, for easy sharing among peer central servers CS for re-use and deployment at various edge computing devices ECD.

In case the platform-independent assembly program is interpreted by the interpreting software function ES at the edge computing device ECD (which is also possible in some embodiments), such interpretation is typically faster than the interpretation of the internal execution plan language, at least in case it represents several predicates.

In some embodiments the assembly program contains one or several special instructions arranged to, when invoked, call the interpreter for internal language code that cannot be, or is not, translated into binary code. For example, it may be necessary to call the interpreter when starting the processing of a new stream. This makes it possible to eliminate parts or all of the interpreter for the execution language on small edge computing devices ECD.

Hence, the interpreting software function ES of each edge computing device ECD can be configured to interpret the internal execution plan language and/or the assembly language, as the case may be.

A full engine may hence be provided with, and handle, code (corresponding to the query or part of the query) defined in the internal execution plan language; in the assembly language; and/or in the platform-specific binary code, and can then handle each of these instances by its locally installed and executing interpretating software function ES. To the contrary, a thin engine may be configured to always only receive respective platform-specific binary code. In the latter case no interpreter for the execution language is needed.

All parsed, compiled, optimized and transcribed code may be cached and/or shared among different central servers CS, for re-use. As an example, when adding a new target architecture for edge computing devices ECD, it is straightforward to implement a transcriber backend for this new target architecture. As all code optimizations are done on a higher level (when defining the execution plan), the transcription can be performed centrally and thereafter automatically be disseminated to all concerned devices, such as on the fly when needed.

As mentioned, thin engine edge computing devices ECD may be configured not to include query processing algorithms, and their interpreting software function ES can as such then not define but only execute optimized and compiled execution plans as illustrated in FIG. 10 (the interpreting software function ES then only comprises an internal execution plan language interpreter and downstream components, or in some embodiments only downstream components). In the example of SLOG discussed above, the internal execution plan language interpreter may be a SLOG interpreter, available on thin engine edge computing devices ECD and configured to manage SLOG primitives for which the SLOG compiler cannot generate assembly code. For thin engine edge computing devices ECD, the execution plan can generally contain pointers to binary code fragments that are invoked by the internal execution plan language interpreter when encountered in the execution plan, and therefore such thin engine edge computing devices ECD can also manage such pointed-to binary code comprised in the interpreted execution plan.

There may be computer architectures for which no binary code generator (such as no SLAP binary code generator) is implemented, or computers for which it is not allowed for platform reasons to dynamically generate binary code, e.g. in OS X devices. To manage this, the system 100 can also comprise an assembly program (such as SLAP) byte code interpreter as part of an interpreting software function ES on at least some edge computing devices ECD, that interprets assembly program instructions on computers where the assembly program language cannot be transcribed into binary code. This is also illustrated in FIG. 10. In this case the execution plan may contain pointers to code fragments represented as platform-independent assembly language instructions, for which the internal execution plan language interpreter can call the assembly program interpreter of the interpreting software function ES.

Reverting now to the issue of arrays discussed initially in the present description, the following terminology will be used in the following.

A “multi-dimensional array” is a cube of objects. In principle, the objects can be of any type but, without loss of generality and for reasons of simplicity, it will be assumed herein that they are numbers. The cube can have one or more dimensions. For example, a matrix is a 2-dimensional (2D) array of numbers, while a vector is a 1D array. Multi-dimensional arrays with higher dimension than two are called tensors.

A multi-dimensional array has a “shape”, being the number of elements for each dimension. For example, a 3×5 matrix has the shape defined by the vector [3,5].

The number of elements in an array for a particular dimension is called the “length” of the dimension. For example, a 2×3 matrix has length 3 of the 2nd dimension.

The elements of an array are represented in the computer memory in some “format”. For example, a floating-point number can be represented in 32-bits (format F32), while a small integer can be represented with 8-bits (format 18). In some embodiments, all elements of an array have the same format.

Multi-dimensional array elements can be accessed through “indexing”. For example, element A_{i,j} of a matrix (2D array) A can be accessed with the notation a[i,j]. Without loss of generality, index numbers used herein are from 1 and upwards.

Sections of multi-dimensional arrays can also be accessed through “slicing”. For example, the vector representing row 2 of a matrix A can be denoted as A[2,*] while column 3 of A can be denoted A[*,3].

As mentioned above, embodiments of the present invention relate to array queries in the sense that declarative queries can be defined in terms of possibly multi-dimensional and/or dense arrays.

Moreover, array queries can be used to define such data arrays.

More particularly, FIG. 11 illustrates a method for processing multi-dimensional data, the data comprising one or several arrays.

For this and other methods described herein, each individual step can be performed by the same or different ones of the various component parts CS, ECD of the system 100 described herein. In particular, a computer software product of the type described herein can be arranged to, when executed on one or several of the component parts CS, ECD, perform one or several of these method steps.

In a first step, the method starts. In a subsequent step, a non-procedural declarative definition is identified of a data array.

This definition of the data array may comprise the rank and a shape of the data array, with meanings as explained above. The definition of the data array is in the form of an “array query”, meaning that the definition has the syntactical format of a query and that the query directly or indirectly, but unambiguously, defines an array, possibly comprising the rank, shape and/or individual element values of the array. In some cases, the data array can have a static rank, or the data array can have a dynamically or even variably determined rank. Correspondingly, for each individual dimension of the data array a corresponding shape can be static, or dynamically or variably determined. Each individual element value can follow directly or indirectly from the array query definition, as a static or dynamically or even variably determined value. For instance, each individual element value can be or comprise a constant, a variable or a function. The final value of each element can be determined as a part of the calculation of the array based on the array query definition, or be determined at a later point in time based on a definition of the element value in terms ofa defined variable and/or a function call. An array query can be a part of a stream query, such as of an endless stream query, in the sense that such a stream query returns a set of array queries over time. An array query can also be a stream query, in the sense that the individual elements of the array can constitute the elements of the stream query. In this case, at least one dimension of the array can have a non-defined or infinite shape.

In some embodiments, the data array has a rank of at least two, such as a rank of at least three. Each dimension of the data array can have a shape of at least two. In some embodiments, at least one, or even at least two, of the dimensions of the data array has or have a respective shape of at least three, such as of at least ten, such as of at least one hundred.

As mentioned above, the definition is syntactically in the form of a query. The term “query” is generally as used above, and can be an alphanumeric expression defining properties of a desired result of the query in question. Hence, the query can be a plaintext query, for instance expressed in a query language of the general type described and exemplified above or in some other well-defined query language. It is noted that the array query can be defined so using a standard way of syntactically defining a query, while the array query may use one or more array-specific extensions to such query language. The query can be, or be part of, an expression using a predetermined syntax, for instance using the query language, which is processed and used as described above, for instance by edge computing devices ECD and central servers CS requesting information from one another, such as using stream queries as described above. Hence, an array being defined in terms as a query as described herein can form part of a query language expression in turn using the results of the array to perform some subsequent calculation, and so forth. Instead of being in the form of a plaintext expression, it is also possible that the array query is in the form of a partly or completely compiled (binary or assembler code) expression, determined based on a corresponding plaintext expression of the type.

One example of such query syntax is the per se conventional select—from—where syntax of the type used in SQL.

The query can define respective values of individual array elements in the array, the individual array elements being defined using query conditions constraining the values. In particular, the definition can comprise or use integer index variables to refer to indices of the array. This will be explained in the following.

A query of the type, defining a (multi-dimensional) array query, is herein denoted a (multi-dimensional) “array query”. In various embodiments, such an array query can comprise or consist of two parts, herein denoted its “head” and its “condition”:

The head of the query can then specify the shape and format of the array produced by the query. The head can also specify what names are used when array elements are referenced in the condition.

The condition can specify how each element of the result is computed, using a predicate.

For example, assuming variable A is bound to a matrix (2D array), the following multidimensional array query transposes A:

select Array r[i..length(A,2), j..length(A,1)] of I8 e
where e = A[j,i]

$$If A = \begin{matrix}1 \\ 4\end{matrix} \begin{matrix}2 \\ 5\end{matrix} \begin{matrix}3 \\ 6\end{matrix} , the result of the query will be the matrix \begin{matrix}1 \\ 2 \\ 3\end{matrix} \begin{matrix}4 \\ 5 \\ 6\end{matrix} .$$

On the first line, the head of the query specifies that:
1. In the query, the query result is named r and each element of the result is named e.
2. The elements are represented as 8-bit integers, i.e. the format 18.
3. Element e represents r_{i,j}. In other words, the index variable i is bound to a row number and j is bound to a column number.
4. The shape r has the same number of rows as the number of columns in A and the same number columns as the number of rows in A. That is, in r_{i,j} the index i varies from 1 to the number of columns in A, and j varies from 1 to the number of rows in A. Here, the length of dimension d of array a is accessed by the system function length(a,d). For example, the number of rows in A is length (A,1) and the number of columns in B is length(B,2).

On line 2, the query condition states that element e=A_{j,1}.

Analogous to conventional database queries, the semantics of a declarative (multi-dimensional) array query can have a generator stage followed by a computation stage:

The generator stage then allocates an empty result array based on the information in the head of the array query. The exact size is determined by its shape and format.

The filter stage then defines the elements of the array based on the array query condition.

In some embodiments, and in the presently discussed example, the detailed procedural program code that is needed to compute the elements of a (multi-dimensional) array for a given query condition is not specified in the query, but is instead automatically generated by the query optimizer based on the specified rank, shape, and query condition.

In some embodiments, a property of such multi-dimensional array queries is that the size and/or format of the result is specified in the query head. Furthermore, the data types of all variables used in the query condition can also be specified in the query head. This enables the query optimizer to know how to physically represent the array and efficiently optimize and compile the query.

It is understood that queries of the present type, and particularly using a query language such as the ones described and exemplified herein, can generally be defined using a predetermined syntax, such as a query syntax of the type described above. Then, the predetermined syntax comprises rules for how to define the queries, including aspects as specifying the size and format of the array in the query head.

In the presently discussed example, the shape and format are known for the array object to which A is bound, since array objects such as A have associated shapes and formats as metadata. The types of index variable such as i and j are always integers. The type of elements stored with format 18, such as e, is also integer. The type of the result array r is Array of 18, denoting an array whose elements are represented with format 18. The user can furthermore declare the types of local variables not specified in the query head.

Based on these declarations the query optimizer can generate a typed execution plan for which a dynamic JIT compiler generates highly efficient binary code.

In some embodiments, the query condition can be configured to reference array slices. Array slices are then translated by the query optimizer into equivalent predicates over array elements. For example, assume that both A and B are bound to matrices and we want to compute a new matrix m as the cartesian product of A and B, i.e

$${m}_{i , j} = {\sum }_{k = 1}^{n} {A}_{i , k} {B}_{k , j} .$$

With the presently described syntax for multi-dimensional array queries, this is expressed as the following array query:

select Array m[i..length(A,2),j..length(B,1)] of F32 e
where e = dot(A[i,*],B[*,j])

In the condition of the multi-dimensional array query on line 2, the array slicing A[i,*] represents the vector being the i:row of A, while B[*, j] represents the j:th column of B. The definition specifies that each element e (i.e. m_{i,j}) is computed as the dot product (scalar product) of the vectors representing row i in A and column j in B.

Furthermore, functions can be defined in terms of (multi-dimensional) array queries. Typically, a function has a signature specifying the name of the function along with the names and types of its arguments and result. The function also has a body being a predicate to define the result for given arguments.

For example, assume we want to define a function that computes the two-dimensional Gaussian kernel distribution, expressed hence:

$$f ( x , y ) = A exp ( - ( \frac{{( x - {x}_{0} )}^{2}}{2 {σ}_{x}^{2}} + \frac{{( y - {y}_{0} )}^{2}}{2 {σ}_{y}^{2}} ) ) ,$$

$$where A = \frac{1}{d \sqrt{2 π}} .$$

We want to define a function gaussian2(n,d) having two arguments, n and d, that computes a matrix f representing the 2D normal distribution with standard deviation d having n point with origo in n/2, i.e. x₀=y₀=n/2, and σₓ=σ_{y}=d in the formula. This is a common computation in image processing.

Using the presently discussed syntax for multi-dimensional array queries, a function gaussian2(n,d) is defined that returns the two-dimensional n×n array f(x,y):

```
create function gaussian2(Integer n, Real d)−>Array
  as select Array f[x..n,y..n] of F32 f
      from Real a, Integer o
    where f = a * exp(−(((x − o)\hat{ }2 + (y − o)\hat{ }2) / 2 * d\hat{ }2))
      and o = n/2
      and a = 1 / d * sqrt(2 * 3.414)
```

Here, the signature of the function is gaussian2(Integer n, Real d)->Array and the body is defined as a multi-dimensional array query in terms of the function's arguments n and d according to the formula. The where clause specifies declarations of the local variables a and o since they are not declared in the function or query heads. This makes the types of all variables used in the query condition known for the query optimizer and compiler.

Multi-dimensional array queries can be used for wrapping external data streams in order to collect and compare readings from different edge computer devices ECD 110, 120, 130, 140, as generally illustrated in FIG. 2 and as discussed above.

Hence, the different edge computing devices ECD 110, 120, 130, 140 can each have a respective sensor arranged to measure some physical value, for instance vibrations. A central server CS, that may be called a “mediator”, runs in the cloud, collects data from the edge computing devices ECD 110, 120, 130, 140 and produces alerts when significant phenomena are detected by one, some or all of the edge computing devices 110, 120, 130, 140. For example, the mediator central server CS can produce a stream of alerts that, at each point in time, indicates which, if any, of the edge computing devices ECD 110, 120, 130, 140 are vibrating too much at the moment. It is understood that FIG. 2 shows two central servers CS, but that the use of only one such central server CS could be possible, or the use of two or more central servers CS that collaborate or that use a common parent central server CS, as has been generally described above. In the following, for reasons of simplicity the description assumes that there is only one mediator central server CS, common for and in communication with all concerned edge computing devices ECD 110, 120, 130, 140.

A naïve implementation of this scenario would be to send all raw sensor readings to the mediator central server CS and there continuously execute a query to compute what edge computing devices ECD 110, 120, 130, 140 produce significant measurements. To avoid continuously sending all the data to the mediator central server CS, each of the edge computing devices ECD 110, 120, 130, 140 can instead run a local query processing engine (a wrapper, generally described above), that locally determines when significant measurements are detected on the edge computing device ECD 110, 120, 130, 140 where the wrapper is running and only sends data to the mediator central server CS when that happens. This will reduce the communicated data volume quite significantly.

Such a wrapper can be expressed in terms of a query over arrays of streams of readings from the sensor that produces a stream of arrays of alerts, in turn being sent to the mediator central server CS.

For example, assume that each such wrapper should send a stream of vectors (1D arrays) [ts,id,al] when significant vibrations start or stop happening. In each such triplet, ts is a time stamp for the vibration, id is the identity of the edge computing device ECD 110, 120, 130, 140 where it was detected, and a1 is 1 if a vibration started at the time or 0 if the vibration stopped.

Assume also that there are external sensors on the edge computing devices ECD 110, 120, 130, 140 each producing a stream of arrays of accelerometer readings [x,y,z] for the three spatial dimensions. The wrapper should send a triplet [ts,id,al] to the mediator central server CS only when significant vibration changes are detected.

Finally, assume that the accelerometer sensor is accessed in the wrapper through a function with the following signature:
create function accelerometer( )->Stream of Array of F32

The wrapper model can now be defined by these three functions:

```
create function magnitudes(Array w[n,c] of F32)−>Array
    as select Array r[i..n] of F32 e
  where e = sqrt(sum(square(w[i,*])));
create function vibrates(Number th) −> Stream of Number
    as changed(select Stream of shakes
        from Array of F32 w, Array of F32 mag, Number shakes,
          Number stdev
  where w in awinagg(accelerometer( ),50,5)
    and mag = magnitudes(w)
    and stdev = stdev(mag)
    and shakes = case when stdev > th then 1
            else 0 end);
create function detect_vibrations(Number th) −> Stream of Array of F32
    as select Stream of [now( ),myid( ),al]
        from Number al
      where al in vibrates(th);
```

The main wrapper function is vibrates(th). It produces a stream of 1:s and 0:s to indicate whether the wrapped edge computing device ECD 110, 120, 130, 140 is starting or stopping vibrating significantly, respectively, according to the threshold th.

The function detect_vibrations(th) calls vibrates(th) to produce the desired stream of arrays [ts,id,al] sent to the mediator central server CS. In detect_vibrations(th), the function now( ) returns the current time when each element al from vibrates(th) arrives, while myid( ) returns the identity of the edge computing device ECD 110, 120, 130, 140 where the wrapper model is running.

A significant vibration is detected by vibrates(th) when the standard deviation of the magnitude of the 50 latest measurements is larger than th. This is computed for every 5^{th} measurement of [x,y,z] from the accelerometer.

The function accelerometer( ) is called to produce the stream of [x,y,z] measurements.

It is there called as argument to the system function awinagg(s,size,stride), which forms a stream of windows over the stream s where each window is a matrix (2D array) containing the size latest sensor readings and a new array is produced every stride sensor readings.

In this example, the size is 50 and the stride is 5. The helping function magnitudes(w) computes the magnitudes of the rows in window w as a vector (1D array). The system function stdev(a) computes the standard deviation of the elements of a 1D array (vector) a.

As discussed above, array queries, such as multi-dimensional array queries, can generally be defined and provided in a query language of the type described herein, such as the above-described query language OSQL, enabling domain experts to define mathematical functions that in turn can be stored in a system 100 main-memory database. The user can make queries over data stored in the database on a very high level without specifying details of how to execute the queries. The query optimizer can automatically optimize such queries and functions for best performance and memory utilization.

Mathematical OSQL queries and functions can be defined in terms of vectors, matrices, or tensors of varying dimensionality. For this, the presently disclosed efficient query optimization of queries over (multi-dimensional) arrays can be used. Fast processing of numerical algorithms can be provided by query optimization of typed predicates where the user can specify declaratively what to compute, after which the query optimizer automatically determines the details of how to make a computation with a small, or even smallest possible, resource utilization. To enable the highest achievable execution speed, the optimized queries and functions can finally be on-the-fly compiled into binary code based on static typing of variables used in the generated execution plan. At the lowest level, array operations can be performed by a GPU, an FPGA and/or specialized hardware.

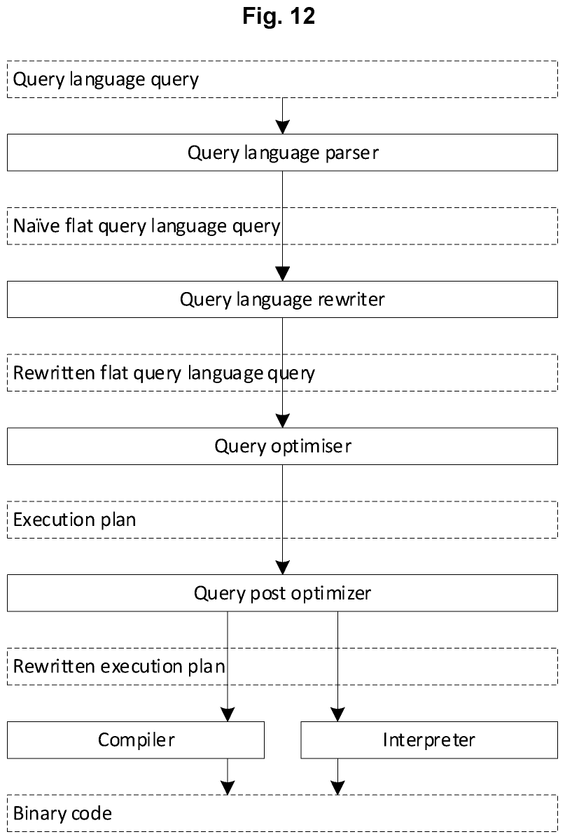

FIG. 12 illustrates the information flow and process from the point of view of acting entities (software modules of the interpreting software function ES of a central server CS) and data on which the acting entities operate. FIG. 12 corresponds to FIG. 9, but is specific to the case of processing of array queries. Hence, everything that has been said in relation to FIGS. 8 and 9 above is equally applicable also to FIGS. 11 and 12 to the relevant extent. For instance, all intermediate representations of information indicated in FIG. 12 can be made inspectable for tuning experts.

Hence, with continued attention directed to the flowchart shown in FIG. 11, in a subsequent step a parser and/or type checker can be configured to transform the original query language (for instance, OSQL) query into an equivalent “naïve” query-language query, that can be partially or completely procedural.

The parser and/or type checker can be configured to add annotations to the naïve query that restrict further transformations and/or to un-nest (unfold) any nested expressions in the original query to produce the naïve query. As the original query has been parsed, the type checker can be arranged to infer static types of all intermediate variables in the query optimization and detect any type errors. This will facilitate the later generation of a statically typed execution plan.

For corresponding reasons, the parser and/or type checker can be configured to add annotations to the naïve query to indicate procedural query functions that cannot, or should not, be reordered by the query optimizer.

After any type checking and annotation, the naïve query can be generated representing straight-forward generation and filter phases. The naïve query can follow exactly the semantics of array queries, in other words the naïve query can be generated to, when run, first produce an empty array for the given shape, rank and format in the query head and then to filter the query condition in the where clause. Thus, the naïve query can be defined such that, when run and after the empty array has been created in the generator phase, predicates will be followed in the filter phase that specify how the elements in the array are to be computed. In some embodiments, all variables used in the naïve query are typed according to the variable declarations in the original query.

Generally, the naïve query can be generated to represent a straight-forward generation and computation of the original query. Furthermore, the naïve query can be configured to define a respective condition constraining the value of each individual array element. This will be exemplified below.

In a subsequent step, a query rewriter can be configured to transform, such as in several steps, the rewritten query language expression into an equivalent rewritten query language expression, which can be simpler and better suited for further optimization.

The query rewriter can be configured to reduce predicates in the naïve query by applying general logical, mathematical and/or computer algebra rules. In general, these rules can comprise one or more of the following types, and one or several of them can be applied iteratively on predicates until the predicates cannot be further reduced:

Firstly, subqueries and/or functions can be in-lined, i.e. substituted for their definitions. This enables the query optimizer to apply its optimization techniques also on subqueries and functions called in queries.

Secondly, overlapping expressions of query fragments can be identified and combined in the naïve query. In particular, such overlapping predicates can be bound to variables by unification (see https://en.wikipedia.org/wiki/Unification_(computer_science)).

Thirdly, static expressions in the naïve query can be evaluated. Expressions that will never change overtime can hence be evaluated at query optimization time once and for all by the query rewriter and replaced by its value. For example, the static expression sqrt(2*3.1414) in the function gaussian2(n,d) can be replaced with 2.50655.

Fourthly, predetermined specific rewrite rules can be identified and applied using pattern matching. Such special rewrite rules can be applied on certain expressions in the query sections, e.g. array slicing expressions in queries can be translated into predicates that are further reduced and combined with other predicates. Furthermore, specific computer algebra rules (https://en.wikipedia.org/wiki/Computer_algebra) can be applied based on knowledge about mathematical functions. For example, for multiplication and addition these rules are applicable: x+0->x and x*1->x.

Fifthly, redundant or not-used query fragments can be removed in the naïve query. Redundant predicates are those whose values are not used anywhere, in other words a form of dead code elimination (https://en.wikipedia.org/wiki/Dead-code elimination) for queries.

It is realized that the type checker, the parser and/or the rewriter can be bundled together into the same logical entity and/or processing step.

In a subsequent step, a query optimizer, such as a cost-based query optimizer, can be configured to optimize the naïve query (such as any non-procedural fragments of the naïve query), and more particularly the rewritten object language query, yielding a procedural execution plan. This execution plan can be of one of the general types described above, and be arranged to, when run, determine the respective values of the array elements.

The produced execution plan can comprise information regarding what data structure is used to represent each individual array element. It can also define, comprise or be associated with a defined order of calculations involved to determine the values of the array so elements. The optimizing work performed by the cost-based query optimizer can hence comprise determining the information and/or the defined order. The execution plan can define the resulting array and its element values completely, in the sense that the execution plan defines all necessary steps to calculate all the element values of the array.

Hence, after the query rewriter has reduced the original query skeleton, the query optimizer can reorder and transform the predicates in each query section to produce a fully optimized and statically typed execution plan. The execution plan can then be or comprise a procedural program where the order of execution of query operations is explicitly or implicitly (but unambiguously) specified or defined. Reordering large predicates is expensive and the performance of the cost-based query optimization can be substantially improved by the preceding rewrites.

In some embodiments, the work of the optimizer comprises reordering and/or transforming the predicates in at least one, some or each non-procedural query fragment of the naïve query and/or the rewritten query. In general, non-procedural query fragments can be subject to optimization, such query fragments being delimited using “guards” in relation to procedural calls that are not to be query optimized.

In some embodiments, a piece of procedural program code needed to compute the respective values of the array elements is defined for the first time as part of the execution plan. This may be true for any such procedural program code occurring in the execution plan. In other words, part of the work performed by the query optimizer can be to formulate such procedural program code based on the non-procedural declarative array definition (the array query) not defining such procedural program code.

The array definition can comprise at least one variable, such as a parameter or a coefficient, whereby the query array definition comprises a data type declaration for the variable or coefficient. In such and other cases, the execution plan can be a typed execution plan, sometimes even a statically typed execution plan. In such and other cases, the naïve query can be a typed query wherein at least one, some, or even all, used variables or coefficients so is or are unambiguously typed.

After the cost-based query optimization, in a subsequent step post-optimization rewrite rules can be applied to the execution plan, to further improve the performance of the execution plan. The same or corresponding rewrite rules as described above can here be applied not to the naïve query but to the execution plan, whereby one or more of the five rules enumerated above can be applied to the execution plan. However, since the execution plan is procedural, these rewrite rules should not change the order in which the execution plan operations are executed or remove code having side effects that must be present for correct execution of the execution plan.

In a subsequent step, at least part of the execution plan, such as the entire execution plan, can be compiled, yielding executable computer programming code arranged to, when executed, determine the respective values of the array elements. Any non-compiled parts of the execution plan can exist in the execution plan as interpretable computer programming code which is unaltered of the compilation step. In other examples, the compilation step can also comprise reformatting or translating computer code existing in the execution plan into a different-format interpretable computer programming code. In all such cases, the result will be computer programming code that is interpretable and/or executable and that, when run, results in the calculation or determination of the respective values of the array elements.

In general, the (post-optimized) execution plan can either be arranged to be directly interpreted by the execution plan interpreter, the execution plan compiler can generate binary code for execution, or a combination of both can be applied for different parts of the execution plan. The execution plan interpreter can call the compiled binary code to combine interpretation of parts of the execution plan that cannot be compiled with parts that are compiled. Several of these aspects have been individually exemplified in detail above.

Hence, each of the various parts of the fully optimized execution plan can be arranged to be interpreted, or can be handed over to the execution plan compiler that in turn generates corresponding byte code followed by specific binary code generators for each underlying hardware architecture. The interpreter will call any compiled sections of the execution plan, as described above.

In a subsequent step, the respective values of the array elements are calculated or determined by executing or running the computer programming code. At this point, the computer programming code can comprise byte code and/or binary machine code, as has been described above.

The calculation of each individual array element value can comprise one or several of a set of many different types of actions, as defined by the array query. In some embodiments, for instance, the calculation comprises at least one algebraic calculation and/or transformation, such as a numerical algebraic or textual calculation and/or transformation, to be applied to calculate the value of at least one array element when calculating the values of the array elements. In some embodiments, the calculation of array elements comprises using values of externally sourced information, such as results of other queries or sub-queries. In some embodiments, the calculation of one or several array element values are performed based on a variable or parameter value that must first become available. Similarly, calculations performed by a GPU, an FPGA or a piece of custom hardware, such as parallel computations, can become available not immediately but after a certain processing time, and the results of such calculations can also be a variable or parameter value that must first become available before being used for the calculations of one or several array element values.

Hence, the method can be configured to wait until such value becomes available before finalizing the calculation of such array element values, or even wait until such value becomes available before finalizing the calculation of the array seen as an atomic dataset. In some cases, one or several independent computations can be performed in parallel threads or processes as other independent computations while waiting for one or several of the mentioned or other computations to be finalized. It is realized that these examples apply to both what the execution plan dictates and to corresponding calculations performed to calculate the actual array element values.

In a subsequent step, the method ends.

It is understood that the array query can form a sub-part of a larger calculation, in the sense that the array defined by the array query can be used and referred to as a data structure by a query that also requests other information, such as a stream query of any of the above-discussed types; and/or in the sense that the values of the array defined by the array query are used in a subsequent calculation performed by a system that may be a system 100 of the general type described above.

In general, the definition of the data array provided by the array query can define at least one of the respective array values in terms of queried data that is fetched from a dataset as specified in the query.

In some embodiments, the method furthermore comprises type-checking the correct use of the respective types of all variables in the array definition, the naïve query and/or the execution plan; inferring static type of any intermediate variables of the definition, the naïve query and/or the execution plan; and/or late binding of any variables of the definition, the naïve query and/or the execution plan, and/or any array elements, the type of which cannot be inferred.

It is understood that the method illustrated in FIG. 12 can be performed by the system 100 described above using the general mechanisms described herein. Hence, a central server CS of the system 100 can be configured to accept, from a querying party and via the digital communication interface IF, the array query as a first query, or a second query comprising or referencing the array query; parse the first query to produce a parsed query expression; produce the execution plan by generating and optimizing the naïve query, the execution plan in turn defining a calculation to be performed based on a measured value from a sensor S; and possibly compile at least part of the execution plan to thereby obtain an at least partly compiled execution plan. This work can be performed by one single central server CS or be shared by several cooperating and communicating central servers CS. It can also be performed by an edge computing device ECD using central server-like functionality of the edge computing device ECD in question. The method can be performed by a computer software product of the type described herein, that can form part of the system 100.

Then, at least one edge computing device ECD of the system 100 can be configured to receive, via the digital communication interface IF and directly or indirectly from the central server CS in question, the at least partly compiled execution plan, and a software function ES of the at least one edge computing device ECD, executing on the CPU of the edge computing device ECD, can be configured to run the received at least partly compiled execution plan to produce a first result to the at least partly compiled execution plan, the interpretation comprising the performance of the calculation of the array element values as described herein.

In the following, examples are provided to illustrate the principles described above to define and calculate arrays based on array queries.

### Example 1

This example illustrates the steps of query optimization by showing how they are automatically applied for the example of a function mytranspose(a) that transposes the matrix a of 8-bit integers (denoted by format I8), defined in OSQL as:

1 create function mytranspose(Array a[d1,d2] of I8) −> Array
2 as select Array r[i..d2, j..d1] of I8 e
3 where e = a[j,i]

The syntax Array A[D] of F in the function's signature declares that the integer variables in D represent the lengths of the dimensions of array A, whose elements have the format F.

Steps 1 of the query processing generates a naïve annotated OSQL query, which is an equivalent OSQL function definition where the multi-dimensional array query and the signature are translated to a partially procedural query condition. It is expressed by a select-from-where query in which the select clause specifies the result, the from clause declares the types of the local variables in the query, and the where clause is a predicate where all nested function calls have been flattened out. In OSQL, the flattened mytranspose (a) will look like this:

1 create function mytranspose(Array of I8 a)−>Array

| | |
|---|---|
| 2 | /* Optimization step: FLAT */ |
| 3 | as select r |
| 4 | from Array of I8 r, Integer d1, Integer d2, Integer i, Integer j, |
| 5 | Integer e, Memory _rm, Integer _rmi, Memory _v2, Vector |
| | of |
| 6 | Integer _v5, Integer _v10, Integer _v11, Integer _v12, |
| | Integer |
| 7 | _v13, Integer _v14, Integer _v16, Integer _v17 |
| 8 | where _v2 = data(a) |
| 9 | and d1 = length(a,1) |
| 10 | and d2 = length(a,2) |
| 11 | and _v5 = [d2,d1] |
| 12 | and r = _new_array(2,_v5) |
| 13 | and _rm = data(r) |
| 14 | and _do(i in range(d2) |
| 15 | and j in range(d1) |
| 16 | and _v10 = in_range(j,1,d1) |
| 17 | and _v11 = _v10 − 1 |
| 18 | and _v12 = _v11 * d2 |
| 19 | and _v13 = in range(i,1,d2) |
| 20 | and _v14 = _v12 + _v13 |
| 21 | and e = _vref_i8(_v2,_v14) |
| 22 | and _v16 = i − 1 |
| 23 | and _v17 = _v16 * d1 |
| 24 | and _rmi = _v17 + j |
| 25 | and _setf_i8(_rm,_rmi,e)); |

Internal system generated variables and operators in the flattened OSQL are prefixed with a_. The user is not allowed to use them.

The predicates on lines 9-13 allocate the result array r, i.e. the generator phase.

In the execution plan above the operator _do(pred) on line 14 tests if pred is true without binding any variables. The do operator on line 14 specifies that the conjunction on lines 14-25 should be executed to populate query result array r.

Predicates in rewritten OSQL may have side effects. For example, the predicate _setf_i8(_rm, _rmi, e) on line 25 updates position _rmi in the memory area _rm that stores the elements with format 18 of the query result array r. To guarantee that the side effects are executed as intended, the optimizer regards predicates with side effects as guards for the optimizer over which it is not allowed to reorder predicates or query fragments.

The function in_range(x,l,u) on lines 16 and 19 checks that the array indexes are within bounds. The function has the definition:

```
create function in_range(Number x, Number l, Number u) −> Number
  as select x
    where x >= l
      and x <= u.
```

After applying the query optimization steps the execution plan looks like this:

```
create function mytranspose(Array of 18 a) −> Array
  /* Execution plan */
  as select r
      from Array of I8 r, Integer d1,
          Integer d2, Integer i, Integer j,
          Integer e, Memory _rm, Integer _rmi,
          Memory _v2, Vector of Integer _v5, Integer _v11,
          Integer _v12, Integer _v14, Integer _v16,
          Integer _v17
    where _v2 = data(a)
      and d1 = length(a,1)
      and d2 = length(a,2)
      and _v5 = new_vector(2)
      and _setf(_v5,1,d2)
      and _setf(_v5,2,d1)
      and r = _new_array(2,_v5)
      and _rm = data(r)
      and _do(i in iota(1,d2)
        and _v16 = i − 1
        and _v17 = _v16 * d1
        and j in iota (1,d1)
        and _v11 = j − 1
        and _v12 = _v11 * d2
        and _v14 = _v12 + i
        and e = _vref_i8(_v2,_v14)
        and _rmi = _v17 + j
        and _setf_i8(_rm,_rmi,e));
```

The execution plan is a procedural OSQL function where the order of all predicates is explicitly specified. The query reduction methods described above make the program smaller than the flattened query. For example, query functions (i.e. subqueries) like in_range( ) have been in-lined and then eliminated by computer algebra transformations. Calls to range (n) have been replaced with calls to the function iota(m,n) that generates bindings of integers between m and n in a loop. For example, in the optimized function calls to in_range( ) have been eliminated as the range tests inside in_range( ) are redundant since the preceding iota calls guarantee that no range test is needed.

Substantial further performance improvements are provided by dynamically compiling the execution plan into equivalent instructions in an internal assembly language like the above-described language SLAP. From SLAP there are binary code generators for a number of backend architectures to generate executable binary code. For architectures where binary code cannot be generated, there is furthermore a SLAP byte code interpreter. Even though the byte code interpreter is substantially faster than the execution plan interpreter, the latter is required for such execution plan constructs that cannot be compiled. The function mytranspose( ) fully compiled looks like the following:

| | | |
|---|---|---|
| create function | L49: mov rcx,qword | L126: mov r8,qword |
| mytranspose(Array of | ptr[rbp−40] | ptr[rbp−16] |
| I8 a) −> Array | L53: call qword | L130: mov edx,1 |
| /* Optimization | ptr[rbx−24] ; MEMPTR | L135: mov rcx,r12 |
| step: SLAP */ | L56: mov r15,rax | L138: call qword |
| as select r | L59: dec r15 | ptr[rbx−72] ; SETI |
| from Array of I8 r | L62: mov edx,1 | L141: cmp rax, 0 |
| where r = _slap(‘ | L67: mov rcx,qword | L145: je L407 |
| .code ; x86-64 win | ptr[rsi+8] | L151: mov r8,qword |
| L0: push rbx | L71: call qword | ptr[rbp−24] |
| L1: push rbp | ptr[rbx+232] ; | L155: mov edx,2 |
| L2: push rsi | AXISLEN | L160: mov rcx,r12 |
| L3: push rdi | L77: mov qword | L163: call qword |
| L4: push r12 | ptr[rbp−24],rax | ptr[rbx−72] ; SETI |
| L6: push r13 | L81: mov edx,2 | L166: cmp rax,0 |
| L8: push r14 | L86: mov rcx,qword | L170: je L407 |
| L10: push r15 | ptr[rsi+8] | L176: mov r8,qword |
| L12: mov rbp,rsp | L90: call qword | ptr[rsi] |
| L15: sub rsp,88 | ptr[rbx+232] ; | L180: mov r8,qword |
| L19: mov rbx,rcx | AXISLEN | ptr[r8+24] |
| L22: mov rsi,rdx | L96: mov qword | L184: add r8,2 |
| L25: call qword | ptr[rbp−16],rax | L188: mov rdx,r12 |
| ptr[rbx+456] ; | L100: mov rdx,qword | L191: mov ecx,2 |
| INTRPTR | ptr[rsi] | L196: call qword |
| L31: mov qword | L104: mov rdx,qword | ptr[rbx+208] ; |
| ptr[rbp−48],rax | ptr[rdx+24] | NEWARRE |
| L35: mov rcx,qword | L108: add rdx,3 | L202: mov rcx,rax |
| ptr[rsi+8] | L112: mov ecx,2 | L205: mov qword |
| L39: call qword | L117: call qword | ptr[rsi+16],rcx |
| ptr[rbx+224] ; | ptr[rbx+192] ; | L209: call qword |
| ARRMEM | NEWVEC | ptr[rbx+224] ; |
| L45: mov qword | L123: mov r12,rax | ARRMEM |
| ptr[rbp−40],rax | | L215: mov r12,rax |
| L218: mov rcx,r12 | L310: cmp r13,qword | L386: mov byte |
| L221: call qword | ptr[rbp−24] | ptr[rdi+1*rdx],ecx |
| ptr[rbx−24] ; MEMPTR | L314: jle L302 | L389: ret |
| L224: mov rdi,rax | L316: mov rax,qword | L390: mov rcx,rsi |
| L227: dec rdi | ptr[rbp−48] | L393: mov rax,qword |
| L230: mov r14,1 | L320: mov eax,qword | ptr[rbx−128] ; |
| L237: jmp L247 | ptr[rax] | CONTEN |
| L239: call L258 | L322: cmp rax,0 | L397: jmp L411 |
| L244: inc r14 | L326: je L339 | L399: pop rax |
| L247: cmp r14, qword | L328: sub rsp,40 | L400: pop rax |
| ptr[rbp−16] | L332: call qword | L401: mov rcx,rsi |
| L251: jle L239 | ptr[rbx−104] ; | L404: call qword |
| L253: jmp L390 | CINTRPT | ptr[rbx−112] ; |
| L258: mov rcx,r14 | L335: add rsp,40 | OVERFLW |
| L261: dec rcx | L339: ret | L407: mov rax,qword |
| L264: jo L400 | L340: mov rcx,r13 | ptr[rbp+64] |
| L270: mov qword | L343: dec rcx | L411: add rsp,88 |
| ptr[rbp−32],rcx | L346: jo L399 | L415: pop r15 |
| L274: mov rax,qword | L352: imul rcx,qword | L417: pop r14 |
| ptr[rbp−32] | ptr[rbp−16] | L419: pop r13 |
| L278: imul rax,qword | L357: jo L399 | L421: pop r12 |
| ptr[rbp−24] | L363: add rcx,r14 | L423: pop rdi |
| L283: mov qword | L366: jo L399 | L424: pop rsi |
| ptr[rbp−32],rax | L372: movzx ecx,byte | L425: pop rbp |
| L287: jo L400 | ptr[r15+1*rcx] | L426: pop rbx |
| L293: mov r13,1 | L377: mov rdx,qword | L427: jmp eax |
| L300: jmp L310 | ptr[rbp−32] | end |
| L302: call L340 | L381: add rdx,r13 | ’,a); |
| L307: inc r13 | L384: jo L399 | |

### Example 2

This example illustrates how slicing is translated into rewritten OSQL, which is then optimized. The original OSQL function is the following:

1 create function rowsum(Array a[d1,d2] of I16)−>Array
2 as select Array r[i..d1] of I16 e
3 where e = sum (a[i,*])

The function makes a 1D array of the sums of the columns in a. The rewritten flattened OSQL code becomes:

```
  1 create function rowsum(Array of I16 a)−>Array
  2 /* Flat OSQL */
```

| | |
|---|---|
| 3 | as select r |
| 4 | from Array of I16 r, Integer d2, Integer d1, Memory _m, |
| 5 | Integer i, Integer e, Array of I16 _v21, |
| 6 | Vector of Integer _v5, Memory _v2, Number _v36, |
| 7 | Number _v35, Integer _v34, Vector of Integer _v33, |
| 8 | Memory _v32, Integer _v30, Integer _v29, Integer _v27, |
| 9 | Integer _v26, Integer _v24, Memory_v23 |
| 10 | where _v2 = data(a) |
| 11 | and d1 = length(a,1) |
| 12 | and d2 = length(a,2) |
| 13 | and _v5 = [d1] |
| 14 | and r = _new_array(4,_v5) |
| 15 | and _m = data(r) |
| 16 | and _do(i in iota(1,d1) |
| 17 | and _v33 = [d2] |
| 18 | and _v21 = _new_array(4,_v33) |
| 19 | and _v23 = data(_v21) |
| 20 | and _do(_v24 in iota(1,d2) |
| 21 | and _v32 = data(a) |
| 22 | and i = _v30 + 1 |
| 23 | and _v29 = _v30 * d2 |
| 24 | and _v27 = _v29 + _v24 |
| 25 | and _v26 = _vref_i16(_v32,_v27) |
| 26 | and _setf_i16(_v23,_v24,_v26)) |
| 27 | and _assign(e,0) |
| 28 | and _do(_v36 = vref(_v21,_v34) |
| 29 | and _v35 = e + _v36 |
| 30 | and _assign(e,_v35)) |
| 31 | and _setf_i16(_m,i,e)) |

The slicing expression a[i,*] is rewritten to the predicates on lines 20-26. On line 20, the variable v24 is bound to each of the index numbers of the columns in a. The memory area of a is accessed on line 21. On lines 22-24, the index numbers in the memory area are computed after which the memory area is accessed on line 25 and assigned to the slice on line 26. Lines 27-30 compute the sum, which is assigned to the result array on line 31.

Using the presently described techniques for defining and calculating the elements of arrays, using array query definitions, the present inventors have been able to achieve more than twice as fast calculations of arrays using only modest bodies of computer code. Typical fields of applications where such savings are realistic include image processing and neural networks.

Above, preferred embodiments have been described. However, it is apparent to the skilled person that many modifications can be made to the disclosed embodiments without departing from the basic idea of the invention.

For instance, the edge computing devices ECD may take many different forms in terms of hardware and software platforms. Since the interpreting software function ES is easily ported and can run in a way essentially independent from the details of its environment (much like Java code), it can be deployed and operated on nearly any general-purpose programmable hardware which is connected to a computer network such as the internet in at least one of the forms described above. The same system 100 may comprise many different types of edge computing devices ECD without having to take special consideration to other things than hardware limitations of each edge computing device ECD.

In some embodiments the device is only intermittently connected to a computer network, in which case the installation of the execution plans is delayed until when the device is later connected to the network.

In some embodiments, the device may be connected to the internet only when the (compiled) execution plans are installed on the device. The execution plans are after that run autonomously without connecting to the network again.

The above description describes numerous different embodiments. In general, all embodiments are freely combinable as long as nothing else is said and as long as they are compatible.

This should frequently be the case, in particular regarding the definition and calculation of arrays using array query definitions. Such array queries can form part, in many different ways, of more complex calculations and/or computer programs defined, performed and executed by the various parts of the system 100.

As another example, edge computing devices ECD and/or central servers CS may pose queries to each other in tree structures, as described herein. In such cases, each pair of querying entity and queried entity may function as a respective central server CS in relation to a respective edge computing device ECD in terms of the parsing, compiling, optimization and transcribing of query code as also described herein. Such querying can hence take place in multiple layers of devices.

Hence, the invention is not limited to the described embodiments, but can be varied within the scope of the enclosed claims.

1. A method for processing multi-dimensional data in a computer system, the computer system having a database, the method comprising:
identifying or providing a non-procedural declarative definition of a data array, the definition comprising the rank and a shape of the data array, the definition being syntactically in the form of a query to the database, wherein in the query respective values of individual array elements are defined using query conditions constraining the values, the definition defining at least one of the respective array values in terms of queried data that is fetched from a dataset as specified in the query;
generating a naïve query representing a straight-forward generation and computation of the query, the naïve query defining a respective condition constraining the value of each array element;
optimizing the naïve query using a query optimizer, yielding a procedural execution plan arranged to, when run, determine the respective values of the array elements, the execution plan comprising both information regarding what data structure is used to represent the array elements and also a defined order of calculations involved to determine the values of the array elements, the optimizing comprising determining both the information and the defined order; and
calculating the respective values of the array elements by executing or running computer code of the execution plan.

2. The method of claim 1, further comprising:
before the step of calculating, compiling at least part of the execution plan, yielding the computer code of the execution plan in the form of executable computer code arranged to, when executed, determine the respective values of one or several of the array elements, and
wherein the step of calculating comprises executing the executable computer code.

3. The method of claim 1, wherein:
the execution plan at least partly is in the form of interpretable computer code arranged to, when interpreted, determine the respective values of one or several of the array elements, and
the step of calculating comprises interpreting the interpretable computer code.

4. The method of claim 1, wherein the execution plan comprises at least one algebraic transformation to be applied to calculate the value of at least one array element.

5. The method of claim 3, wherein the algebraic transformation is a numerical algebraic or textual transformation.

6. The method of claim 1, wherein the calculation of the array values comprises at least one algebraic calculation to be performed to determine the value of at least one array element.

7. The method of claim 1, wherein the computer code is byte code or binary machine code.

8. The method of claim 1, wherein the data array has a rank of at least two.

9. The method of claim 1, wherein the definition comprises or uses integer index variables to refer to indices of the array.

10. The method of claim 1, wherein a procedural program code needed to compute the respective values of the array elements is defined for the first time by the execution plan.

11. The method of claim 1, wherein:
the definition comprises at least one variable, such as a parameter or a coefficient,
the definition comprises a data type declaration for the variable; and
the execution plan is a typed execution plan.

12. The method of claim 11, wherein the execution plan is a statically typed execution plan.

13. The method of claim 10, wherein the naïve query is a typed query wherein at least one, some, or even all, used variables is or are unambiguously typed.

14. The method of claim 11, further comprising:
type-checking the correct use of the respective types of all variables in the definition, the naïve query and/or the execution plan;
inferring static type of any intermediate variables of the definition, the naïve query and/or the execution plan; and/or
late binding of any variables of the definition, the naïve query and/or the execution plan, and/or any array elements, the type of which cannot be inferred.

15. The method of claim 1, further comprising:
rewriting the naïve query by applying rules, such as logic or mathematical rules, such as comprising one or more of:
a) identifying and combining overlapping expressions of query fragments in the naïve query;
b) evaluating static expressions in the naïve query;
c) predetermined specific rewrite rules identified using pattern matching; and
d) removing redundant or not-used query fragments in the naïve query.

16. The method of claim 1, further comprising:
rewriting the execution plan by applying logic rules, such as comprising one or more of:
a) identifying and combining overlapping expressions in the execution plan;
b) evaluating static expressions in the execution plan;
c) predetermined specific rewrite rules identified using pattern matching; and
d) removing redundant or not-used expressions in the execution plan.

17. The method of claim 16, wherein the rewriting of the execution plan is arranged to preserve the procedural execution order of the execution plan.

18. The method of claim 1, wherein the optimizing comprises reordering and/or transforming the predicates in each query section of the naïve query.

19. The method of claim 1, wherein the execution plan is or comprises a procedural program where the order of execution of query operations to perform is explicitly specified.

20. A method for collecting and processing multi-dimensional data in a computer system, the computer system comprising several edge computing devices and at least a first central server, each computing device and each central server comprising a memory; a Central Processing Unit; and a digital communication interface, arranged to allow digital communication across a digital communication network, each of the edge computing devices also comprising a sensor, the method comprising:
a) accepting, by the central server, from a querying party and via the digital communication interface, a query as a first query, or a second query comprising or referencing the first query, the first query being in relation to a database in the memory, the query syntactically, non-procedurally and declaratively defining a data array, the definition comprising the rank and shape of the data array, wherein in the query respective values of individual array elements are defined using query conditions constraining the values, the definition defining at least one of the respective array values in terms of queried data that is fetched from a dataset as specified in the query;
b) parsing, by the central server, the first query to produce a parsed query expression;
c) producing, by the central server, by generating and optimizing a naïve query, a procedural execution plan in turn defining a calculation to be performed based on a measured value from the sensor, the naïve query representing a straight-forward generation and computation of the query, the naïve query defining a respective condition constraining the value of each array element, the optimizing using a query optimizer to optimize the naïve query, yielding the execution plan arranged to, when run, determine the respective values of the array elements, the execution plan comprising both information regarding what data structure is used to represent the array elements and also a defined order of calculations involved to determine the values of the array elements, the optimizing comprising determining both the information and the defined order;
d) receiving, by at least one of the edge computing devices, via the digital communication interface, the execution plan; and
e) executing or running the execution plan, by a software function of the at least one of the edge computing devices executing on the Central Processing Unit of the edge computing device, to produce a first result to the execution plan, the running comprising the performance of the calculation.

21. A system for processing multi-dimensional data, the system having a database and being configured to:
identify a non-procedural declarative definition of a data array, the definition comprising the rank and a shape of the data array, the definition being syntactically in the form of a query to the database, wherein in the query respective values of individual array elements are defined using query conditions constraining the values, the definition defining at least one of the respective array values in terms of queried data that is fetched from a dataset as specified in the query;
generate the naïve query representing a straight-forward generation and computation of the query, the naïve query defining a respective condition constraining the value of each array element;
optimize the naïve query using a query optimizer, yielding a procedural execution plan arranged to, when run, determine the respective values of the array elements, the execution plan comprising both information regarding what data structure is used to represent the array elements and also a defined order of calculations involved to determine the values of the array elements, the optimizing comprising determining both the information and the defined order; and
calculate the respective values of the array elements by executing or running computer code of the execution plan.

22. The system of claim 21, wherein:
the system comprises several edge computing devices and at least a first central server, each such computing device and each such central server in turn comprising a memory; a Central Processing Unit; and a digital communication interface, arranged to allow digital communication across a digital communication network, each of the edge computing devices also comprising a sensor; and
so the functions of identifying, generating, optimizing, compiling and calculating each is performed by a respective one of the edge computing devices and/or central servers.

23. A non-transitory computer software product for processing multi-dimensional data, the computer software product being configured to, when executed on a system having a database,
identify a non-procedural declarative definition of a data array, the definition comprising the rank and a shape of the data array, the definition being syntactically in the form of a query to the database, wherein in the query respective values of individual array elements are defined using query conditions constraining the values, the definition defining at least one of the respective array values in terms of queried data that is fetched from a dataset as specified in the query;
generate a naïve query representing a straight-forward generation and computation of the query, the naïve query defining a respective condition constraining the value of each array element;
optimize the naïve query using a query optimizer, yielding a procedural execution plan arranged to, when run, determine the respective values of the array elements, the execution plan comprising both information regarding what data structure is used to represent the array elements and also a defined order of calculations involved to determine the values of the array elements, the optimizing comprising determining both the information and the defined order; and
calculate the respective values of the array elements by executing or running computer code of the execution plan.
